(19) United States
(12) Patent Application Publication
(10) Pub. No.: US 2005/0182970 A1
(43) Pub. Date: Aug. 18, 2005

(54) Electronic mail apparatus, electronic mail system, and electronic mail transmission method

(75) Inventor: Kouichi Yasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/102,790

(22) Filed: Apr. 11, 2005

Related U.S. Application Data
(63) Continuation of application No. PCT/JP02/13206, filed on Dec. 18, 2002.

(51) Int. Cl. H04L 9/00

(52) U.S. Cl. 713/201

(57) ABSTRACT

An illegal electronic mail is suppressed from being transmitted by a computer virus, using an electronic mail apparatus (1) having a mail checking part (5). The mail checking part (5) determines whether or not an electronic mail scheduled to be transmitted is an illegal one caused by a computer virus. The determination by the mail checking part (5) is performed by displaying the contents of the electronic mail on a display apparatus (11), and requesting the authentication of personal identification and the confirmation of whether or not a user intends to transmit the electronic mail, with respect to the user. In the case of having received a response to the effect that the user is identified, and a response to the effect that the electronic mail is intended to be transmitted from an input device by the user, from a personal identification authenticating part (6), the mail checking part (5) determines that the electronic mail is not an illegal one, and transmits the electronic mail.

### TECHNICAL FIELD

The present invention relates to an electronic mail apparatus, an electronic mail system, and an electronic mail transmission method, capable of suppressing the transmission of an electronic mail that is not intended by a user, in particular, the transmission of an illegal electronic mail caused by a computer virus.

### BACKGROUND ART

Recently, due to the widespread use of computers and the Internet, the exchange of messages via electronic mails is increasing rapidly. Along with this, computer viruses hereinafter, referred to as “viruses”) utilizing electronic mails are also increasing.

In most cases, when a terminal is infected with a virus, the virus abuses a security hole of mail software, and operates the terminal as if the owner of the terminal operated the terminal. Consequently, the virus and/or an important file are transmitted to an address listed in a mail address book in the terminal, which causes inconvenience to a number of people.

Examples of a method for dealing with such a virus include the introduction of virus disinfection software to a terminal (e.g., JP 2002-196942 A), the execution of virus disinfection service in an Internet service provider (ISP) (e.g., JP 2002-222094 A), and the like. Viruses that have already been found and identified can be dealt with by the above-mentioned methods.

FIG. 19 shows a configuration of a conventional electronic mail system. FIG. 19 shows an example in which virus disinfection software is introduced to a terminal. As shown in FIG. 19, the electronic mail system is composed of an electronic mail apparatus 151 and a mail server 155. An electronic mail transmitted from the electronic mail apparatus 151 is once transmitted to the mail server 155, and transmitted from the mail server 155 to a receiving terminal 157 via the Internet 156.

The electronic mail apparatus 151 is composed of a personal computer. The electronic mail apparatus 151 is also composed of a mail transmitting/receiving part 152 for transmitting and receiving an electronic mail, and a virus disinfecting part 153 for finding and disinfecting a virus by matching data and a program stored in a hard disk or the like with a pattern file 154. The electronic mail apparatus 151 is implemented by installing an electronic mail program for configuring the mail transmitting/receiving part 152 and a virus disinfection program for configuring the virus disinfecting part 153 in a computer, and executing these programs.

Thus, if the virus disinfecting part 153 is configured using the virus disinfection program, a virus transmitted from another terminal via an electronic mail can be disinfected, and a virus that has already entered a computer can be prevented from transmitting a mail without authorization. Therefore, the damage caused by a virus can be prevented.

However, according to the virus disinfection based on the virus disinfection program and the virus disinfection service based on the ISP, a virus is detected by matching with a pattern file. Therefore, there is a problem that a new virus for which a pattern file is not present cannot be dealt with. There is also a possibility that a terminal may be infected with a virus due to a human mistake such as negligence of periodically updating a pattern file by a user or an administrator.

### DISCLOSURE OF INVENTION

In view of the above-mentioned points, it may be very difficult to completely solve the problem that a virus transmits an important file via an electronic mail and the problem that a virus is transmitted to another terminal, with the conventional method for dealing with a virus.

The object of the present invention is to provide an electronic mail apparatus, an electronic mail system, and an electronic mail transmission method, capable of suppressing the transmission of an illegal electronic mail caused by a computer virus.

In order to achieve the above-mentioned object, an electronic mail apparatus according to the present invention capable of suppressing an illegal electronic mail from being transmitted by a computer virus includes a mail checking part for determining whether or not an electronic mail scheduled to be transmitted is an illegal electronic mail caused by the computer virus. In a case of requesting authentication of personal identification with respect to a user and receiving a response to the effect that the user is identified, the mail checking part determines that the electronic mail scheduled to be transmitted is not the illegal electronic mail, and transmits the electronic mail scheduled to be transmitted.

In the above-mentioned electronic mail apparatus according to the present invention, it is preferable that, in a case of requesting, with respect to the user, confirmation of whether or not the user intends to transmit the electronic mail scheduled to be transmitted, in addition to the authentication of personal identification, and receiving the response to the effect that the user is identified and a response to the effect that the electronic mail scheduled to be transmitted is an electronic mail intended to be transmitted by the user, the mail checking part determines that the electronic mail scheduled to be transmitted is not the illegal electronic mail.

It is further preferable that the above-mentioned electronic mail apparatus according to the present invention includes a security apparatus for verifying whether or not the electronic mail apparatus is operated in accordance with an instruction of the computer virus.

It is preferable that the above-mentioned electronic mail apparatus according to the present invention includes an input history monitoring part, wherein the input history monitoring part obtains input history information specifying an input history when the user creates an electronic mail, stores the input history information in the security apparatus, and monitors acquisition of the input history information by the computer virus, and the mail checking part compares the input history information stored in the security apparatus with contents of the electronic mail scheduled to be transmitted, and in a case where an entirety or a part of sentences constituting the electronic mail scheduled to be transmitted is matched with the input history specified by the input history information, the mail checking part transmits the electronic mail scheduled to be transmitted

Furthermore, it is also preferable that the above-mentioned electronic mail apparatus according to the present invention includes a mail determining part for at least determining whether or not an attached file is present in the electronic mail scheduled to be transmitted, wherein, in a case where the mail determining part determines that the attached file is not present, the mail checking part determines that the electronic mail scheduled to be transmitted is not the illegal electronic mail, and in a case where the mail determining part determines that the attached file is present, the mail checking part requests, with respect to the user, authentication of personal identification and confirmation of whether or not the user intends to transmit the electronic mail scheduled to be transmitted, and in a case of receiving a response to the effect that the user is identified and a response to the effect that the electronic mail scheduled to be transmitted is an electronic mail intended to be transmitted by the user, the mail checking part determines that the electronic mail scheduled to be transmitted is not the illegal electronic mail.

In the above-mentioned electronic mail apparatus according to the present invention, it is preferable that, in accordance with an input signal from outside, the mail checking part transmits all electronic mails scheduled to be transmitted, stops transmitting all the electronic mails scheduled to be transmitted, or stops requesting the authentication of personal identification and the confirmation with respect to all the electronic mails scheduled to be transmitted.

Furthermore, it is preferable that the above-mentioned electronic mail apparatus according to the present invention further includes a key distribution managing part, wherein the security apparatus encodes the electronic mail scheduled to be transmitted, and generates and saves a key, the key distribution managing part determines whether or not to admit distribution of the key for decoding the encoded electronic mail scheduled to be transmitted, in a case of determining that the electronic mail scheduled to be transmitted is not the illegal electronic mail, the mail checking part allows the security apparatus to encode the electronic mail and transmits the encoded electronic mail, and in a case where another electronic mail apparatus that has received the encoded electronic mail requests transmission of the key for decoding the encoded electronic mail, the mail checking part distributes the key in accordance with determination by the key distribution managing part.

Furthermore, the above-mentioned electronic mail apparatus according to the present invention may include a mail environment detecting part for detecting an environment for transmitting the electronic mail scheduled to be transmitted, and notifying the mail checking part of a detection result, wherein the mail checking part determines whether or not to request, with respect to the user, the authentication of personal identification and the confirmation of whether or not the user intends to transmit the electronic mail scheduled to be transmitted, based on the detection result.

Next, in order to achieve the above object, a first electronic mail system includes an electronic mail apparatus for detecting and disinfecting a computer virus using a pattern file in accordance with a virus disinfection program, and a mail server. The electronic mail apparatus includes a security apparatus, and the security apparatus at least verifies whether or not the electronic mail apparatus is operated in accordance with an instruction of the computer virus and manages versions of the pattern file and the virus disinfection program, and the mail server contains information specifying updated versions of the pattern file and the virus disinfection program, determines whether or not the versions of the pattern film and the virus disinfection program managed by the security apparatus have been updated, based on the information specifying the updated versions, and in a case of determining that any of the versions has not be updated, the mail server allows the electronic mail apparatus to request, with respect to a user, authentication of personal identification and confirmation of whether or not the user intends to transmit the electronic mail scheduled to be transmitted.

Next, in order to achieve the above-mentioned object, a second electronic mail system according to the present invention includes an electronic mail apparatus and a mail server. The electronic mail apparatus obtains the information specifying a state of the electronic mail apparatus and transmits the information to the mail server. The mail server includes a mail checking part. The mail checking part determines whether or not it is necessary to authenticate personal identification with respect to the user, and it is necessary to confirm whether or not the user intends to transmit an electronic mail scheduled to be transmitted, based on the information transmitted from the electronic mail apparatus. In a case of determining that the authentication of personal identification and the confirmation are necessary, the mail checking part allows the electronic mail apparatus to perform the authentication of personal identification and the confirmation, and in a case of receiving a response to the effect that the user is identified and a response to the effect that the electronic mail scheduled to be transmitted is intended to be transmitted by the user, the mail checking part determines that the electronic mail scheduled to be transmitted is not an illegal electronic mail caused by a computer virus, and allows the electronic mail apparatus to transmit the electronic mail scheduled to be transmitted.

Next, in order to achieve the above-mentioned object, a first electronic mail transmission method according to the present invention capable of suppressing an illegal electronic mail from being transmitted by a computer virus includes the operations of: (a) requesting authentication of personal identification with respect to a user; (b) in a case of receiving a response to the effect that the user is identified, determining that an electronic mail scheduled to be transmitted is not the illegal electronic mail; and (c) in a case of determining that the electronic mail scheduled to be transmitted is not the illegal electronic mail, transmitting the electronic mail scheduled to be transmitted.

In the above-mentioned electronic mail transmission method according to the present invention, it is preferable that the operation (a) includes requesting confirmation of whether or not the user intends to transmit the electronic mail scheduled to be transmitted, with respect to the user, in addition to the authentication of personal identification, and the operation (b) includes, in a case of receiving a response to the effect that the user is identified and a response to the effect that the electronic mail scheduled to be transmitted is intended to be transmitted by the user, determining that the electronic mail scheduled to be transmitted is not the illegal electronic mail.

Furthermore, it is also preferable that the above-mentioned electronic mail transmission method according to the present invention further includes the operations of: obtaining input history information specifying an input history when the user creates an electronic mail; and comparing the input history information with contents of the electronic mail, and in a case where an entirety or a part of sentences constituting the electronic mail scheduled to be transmitted is matched with the input history specified by the input history information, determining that the electronic mail scheduled to be transmitted is not the illegal electronic mail.

Furthermore, it is also preferable that the above-mentioned electronic mail transmission method according to the present invention includes the operations of: determining whether or not an attached file is present in the electronic mail scheduled to be transmitted, and in a case of determining that the attached file is not present, determining that the electronic mail scheduled to be transmitted is not the illegal electronic mail, transmitting the electronic mail scheduled to be transmitted, wherein, in a case of determining that the attached file is present, the operations (a) to (c) are performed.

It is also preferable that the above-mentioned electronic mail transmission method according to the present invention further includes the operations of: in the operation (b), in a case of determining that the electronic mail scheduled to be transmitted is not the illegal electronic mail, encoding the electronic mail scheduled to be transmitted; generating a key for decoding the encoded electronic mail scheduled to be transmitted; in a case where an electronic mail apparatus that has received the encoded electronic mail scheduled to be transmitted requests transmission of the key, determining whether or not a mail address of a transmission destination of the electronic mail is matched with a mail address of the electronic mail apparatus, and whether or not a previously registered domain name is matched with a domain name of a mail address of the electronic mail apparatus; and in a case where the mail address of the transmission destination of the electronic mail is matched with the mail address of the electronic mail apparatus, or in a case where the previously registered domain name is matched with the domain name of the mail address of the electronic mail apparatus, distributing the key.

Furthermore, the above-mentioned electronic mail transmission method according to the present invention may further include the operation of determining whether or not to request, with respect to the user, the authentication of personal identification and the confirmation of whether or not the user intends to transmit the electronic mail scheduled to be transmitted, based on the environment for transmitting an electronic mail.

Next, in order to achieve the above-mentioned object, a second electronic mail transmission method according to the present invention uses an electronic mail apparatus for detecting and disinfecting a computer virus using a pattern file in accordance with a virus disinfection program, and a mail server. The method includes at least the operations of: (a) obtaining versions of the pattern file and the virus disinfection program by the mail server; (b) determining by the mail server whether or not the versions of the pattern file and the virus disinfection program have been updated, based on information specifying updated versions of the pattern file and the virus disinfection program previously stored in the mail server; (c) in the operation (b), in a case of determining that any of the versions has not been updated, the mail server allowing the electronic mail apparatus to request, with respect to the user, authentication of personal identification and confirmation of whether or not the user intends to transmit the electronic mail scheduled to be transmitted.

Next, in order to achieve the above-mentioned object, a third electronic mail transmission method according to the present invention uses an electronic mail apparatus and a mail server. The method includes the operations of (a) allowing the electronic mail apparatus to transmit the information specifying a state of the electronic mail apparatus to the mail server; (b) allowing the mail server to determine whether or not it is necessary to authenticate personal identification with respect to the user and confirm whether or not the user intends to transmit the electronic mail scheduled to be transmitted, based on the information transmitted from the electronic mail apparatus; (c) in a case of determining that the authentication of personal identification and the confirmation are necessary, allowing the electronic mail apparatus to perform the authentication of personal identification and the confirmation; and (d) in a case where the mail server receives a response to the effect that the user is identified and a response to the effect that the electronic mail scheduled to be transmitted is an electronic mail intended to be transmitted by the user, allowing the electronic mail apparatus to transmit the electronic mail.

### BRIEF DESCRIPTION OF DRAWINGS

FIG. 1 is a diagram showing a configuration of an electronic mail apparatus and an electronic mail system according to Embodiment 1 of the present invention.

FIG. 2 is a diagram showing an exemplary configuration of a security apparatus constituting the electronic mail apparatus shown in FIG. 1.

FIG. 3 is a conceptual diagram showing a verification operation by the security apparatus.

FIG. 4 is a flow chart showing mail transmission processing in the electronic mail apparatus according to Embodiment 1 of the present invention.

FIG. 5 is a diagram showing configurations of an electronic mail apparatus and an electronic mail system according to Embodiment 2 of the present invention.

FIG. 6 is a flow chart showing mail transmission processing in the electronic mail apparatus according to Embodiment 2 of the present invention.

FIG. 7 is a diagram showing configurations of an electronic mail apparatus and an electronic mail system according to Embodiment 3 of the present invention.

FIG. 8 is a flow chart showing mail transmission processing in the electronic mail apparatus according to Embodiment 3 of the present invention.

FIG. 9 is a diagram showing configurations of an electronic mail apparatus and an electronic mail system according to Embodiment 4 of the present invention.

FIG. 10 is a diagram showing configurations of an electronic mail apparatus and an electronic mail system according to Embodiment 5 of the present invention.

FIG. 11 is a flow chart showing mail transmission processing in the electronic mail apparatus according to Embodiment 5 of the present invention.

FIG. 12 is a flow chart showing decoding processing of an electronic mail in an electronic mail system according to Embodiment 5 of the present invention.

FIG. 13 is a diagram showing configurations of an electronic mail apparatus and an electronic mail system according to Embodiment 6 of the present invention.

FIG. 14 is a flow chart showing mail transmission processing in the electronic mail apparatus according to Embodiment 3 of the present invention.

FIG. 15 is a diagram showing configurations of an electronic mail apparatus and an electronic mail system according to Embodiment 7 of the present invention.

FIG. 16 is a flow chart showing mail transmission processing in an electronic mail system according to Embodiment 7 of the present invention.

FIG. 17 is a diagram showing configurations of an electronic mail apparatus and an electronic mail system according to Embodiment 8 of the present invention.

FIG. 18 is a flow chart showing mail transmission processing in a mail server of an electronic mail system according to Embodiment 8 of the present invention.

FIG. 19 is a diagram showing a configuration of a conventional electronic mail system.

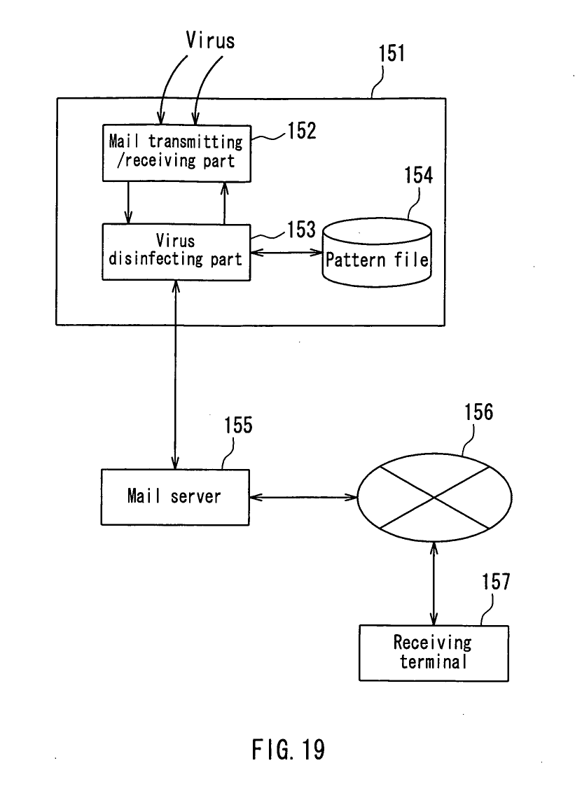

### BEST MODE FOR CARRYING OUT THE INVENTION

### Embodiment 1

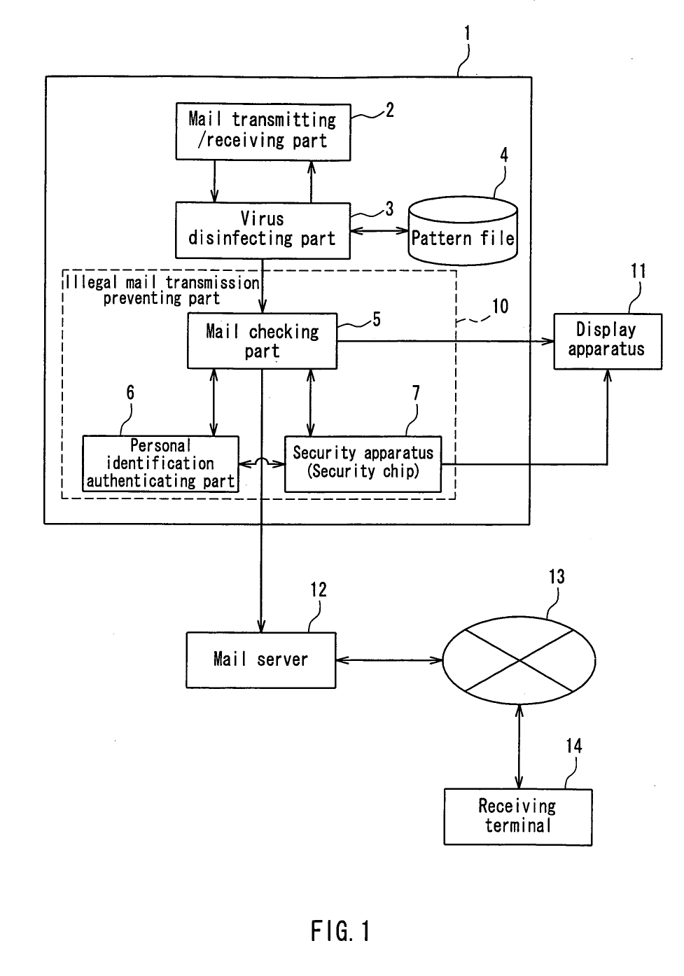

Hereinafter, an electronic mail apparatus, an electronic mail system, and an electronic mail transmission method according to Embodiment 1 of the present invention will be described with reference to FIGS. 1 to 4. First, configurations of the electronic mail apparatus and the electronic mail system according to Embodiment 1 of the present invention will be described with reference to FIGS. 1 to 3.

FIG. 1 shows configurations of the electronic mail apparatus and the electronic mail system according to Embodiment 1 of the present invention. As shown in FIG. 1, the electronic mail system includes an electronic mail apparatus 1 and a mail server 12. The electronic mail apparatus 1 includes a mail transmitting/receiving part 2 for transmitting and receiving an electronic mail, a virus disinfecting part for detecting and disinfecting a computer virus with reference to a pattern file 4, and an illegal mail transmission preventing part 10.

In Embodiment 1, the electronic mail apparatus 1 is composed of a personal computer (hereinafter, referred to as a “PC”). Therefore, the mail transmitting/receiving part 2 is configured by installing an electronic mail program in the PC and executing it. The virus disinfecting part 3 is also configured by installing a virus disinfection program in the PC and executing it. The pattern file 4 is stored in a storage apparatus such as a memory, a hard disk, or the like of the PC.

In the present invention, the electronic mail apparatus 1 may be composed of a computer other than a PC, a portable terminal such as a PDA, a mobile telephone, a car navigation, or the like, and is not particularly limited.

The illegal mail transmission preventing part 10 prevents an illegal electronic mail from being transmitted by a virus that has not been disinfected by the virus disinfecting part 3, the virus disinfection service based on the ISP, or the like. In Embodiment 1, the illegal mail transmission preventing part 10 includes a mail checking part 5, a personal identification authenticating part 6, and a security apparatus 7.

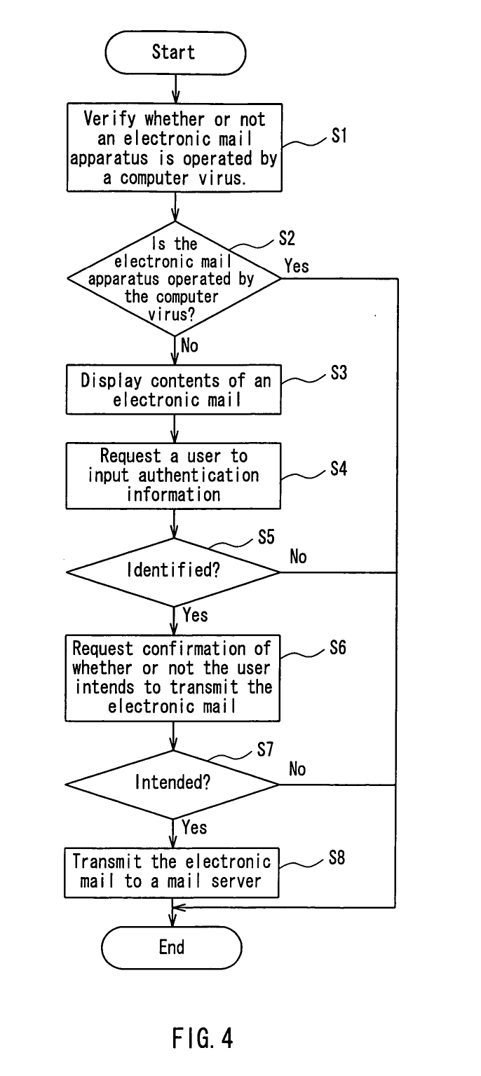

The mail checking part 5 mainly checks an electronic mail to be transmitted by the mail transmitting/receiving part 2, thereby determining whether or not the electronic mail is an illegal one caused by a computer virus. In Embodiment 1, the mail checking part 5 is realized by installing a program for implementing Steps S1 to S7 shown in FIG. 4 described later in the PC and executing it.

In Embodiment 1, the determination of the mail checking part 5 is performed by displaying the contents of an electronic mail to be transmitted, such as a summary, a subject, a transmission destination, and the like, on the display apparatus 11, requesting the authentication of personal identification, and further requesting the confirmation of whether or not the user intends to transmit the electronic mail, with respect to the user.

In Embodiment 1, personal identification is authenticated using the personal identification authenticating part 6. The personal identification authenticating part 6 authenticates the personal identification with respect to the user, and notifies the mail checking part 5 of the result.

In the case of receiving a response to the effect that the user is identified from the personal identification authenticating part 6, and receiving a response to the effect that the electronic mail is intended by the user from an input device (not shown), the mail checking part 5 determines that the electronic mail is not illegal, and transmits the electronic mail to the mail server 12. Thereafter, the mail server 12 transmits the electronic mail to a receiving terminal 14 that is a transmission destination via the Internet 13.

On the other hand, in the case where the mail checking part 5 does not receive a response to the effect that the user is identified from the personal identification authenticating part 6, or does not receive a response to the effect that the electronic mail is intended to be transmitted by the user, from the input device (not shown), the mail checking part 5 determines that the electronic mail is an illegal one, and stops the transmission of the mail.

In Embodiment 1, the personal identification authenticating part 6 displays a request for inputting authentication information such as a password on the display apparatus 11, and authenticates personal identification based on the user's authentication information input in accordance with the display. The personal identification authenticating part 6 is also configured by installing a program in the PC and executing it.

According to the present invention, the personal identification authenticating part 6 is not limited to the above example. For example, the personal identification authenticating part 6 may be a bioauthentication apparatus such as an external fingerprint authentication apparatus and intravenous authentication apparatus. The personal identification authenticating part may be a hardware switch configured so as not to be turned ON/OFF by a program operated on the PC, for example, a hardware switch directly connected to the security apparatus 7.

The security apparatus 7 verifies whether or not the electronic mail apparatus 1 is operated in accordance with an instruction of a computer virus. In Embodiment 1, the security apparatus 7 is composed of one chip.

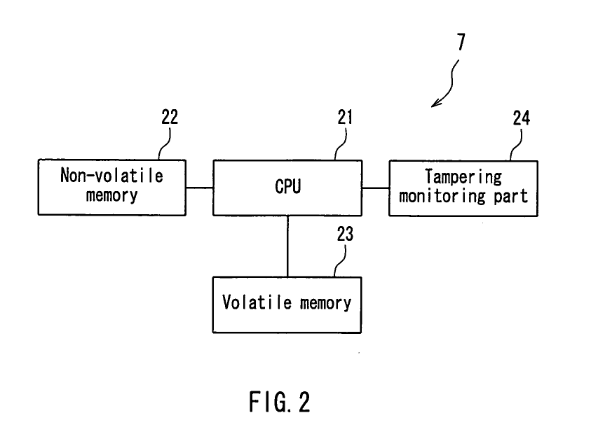

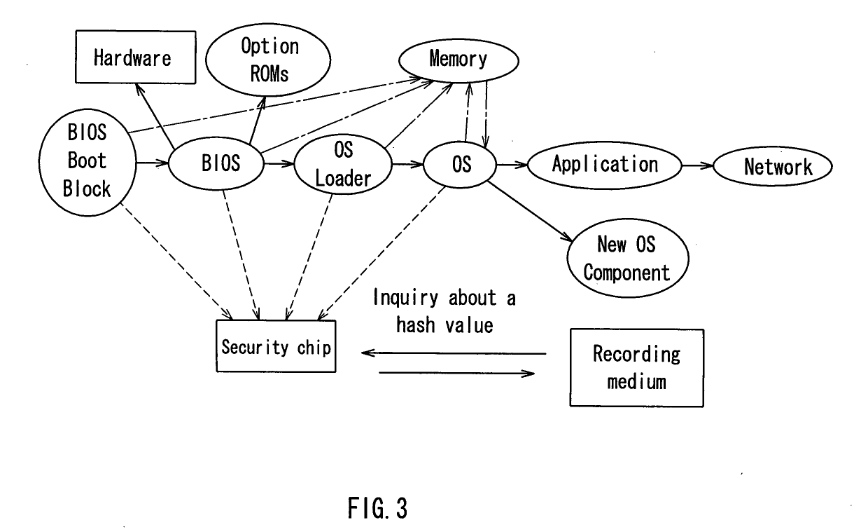

FIG. 2 is a diagram showing an exemplary configuration of the security apparatus constituting the electronic mail apparatus shown in FIG. 1. FIG. 3 is a conceptual diagram showing a verification operation by the security apparatus.

As shown in FIG. 2, the security apparatus 7 includes a CPU 21, a non-volatile memory 22, a volatile memory 23, and a tampering monitoring part 24. The tampering monitoring part 24 monitors whether or not a chip constituting the security apparatus 7 is pulled out of a substrate without authorization, and a chip is inserted in the substrate without authorization, and whether or not data stored in the non-volatile memory 22 and/or the volatile memory 23 is rewritten without authorization.

In Embodiment 1, the security apparatus 7 verifies whether or not the electronic mail apparatus 1 is operated in accordance with an instruction of a computer virus, by detecting a tampered application program.

More specifically, as shown in FIG. 3, from a time when the PC is booted, a secure portion (BIOS Boot Block) on a BIOS calculates a hash value of a program to be activated next, and stores the calculated hash value in the volatile memory 23. Thereafter, in accordance with the instruction of the mail checking part 5, or an external apparatus such as a smart card, a mail server, or the like, the CPU 21 of the security apparatus 7 compares the hash value stored in the volatile memory 23 with the hash value calculated when the program has been activated previously.

Consequently, in the case where the hash value stored in the volatile memory 23 is different from that calculated when the program has been activated previously, it is determined that the program has been tampered. On the other hand, in the case where the stored hash value is not different from the calculated hash value, it is determined that the program has not been tampered.

In Embodiment 1, the hash value calculated when the program has been activated previously is stored in a recording medium that is present outside of the security apparatus, for example, a flash memory card such as a smart card. The present invention is not limited thereto, and the hash value calculated when the program has been activated may be stored in the non-volatile memory 22 in the security apparatus 7.

Next, operations of the electronic mail apparatus and the electronic mail system according to Embodiment 1 will be described with reference to FIG. 4. FIG. 4 is a flow chart showing mail transmission processing in the electronic mail apparatus according to Embodiment 1 of the present invention. The electronic mail transmission method according to Embodiment 1 is performed by operating the electronic mail apparatus and the electronic mail system according to Embodiment 1.

As shown in FIG. 4, first, when the mail checking part 5 is notified by the virus disinfecting part 3 that an electronic mail is transmitted, the mail checking part 5 allows the security apparatus 7 to verify whether or not the electronic mail apparatus 1 is operated in accordance with an instruction of a computer virus (Step S1). In the case where the virus disinfecting part 3 is not configured in the electronic mail apparatus 1, the mail checking part 5 is notified by the mail transmitting/receiving part 2 that an electronic mail is transmitted.

More specifically, the mail checking part 5 allows the security apparatus 7 to verify whether or not programs constituting respective parts other than the mail checking part 5 have been tampered by a computer virus based on the calculation of a hash value. The verification of the program constituting the mail checking part 5 is performed by the security apparatus 7 when the PC is booted.

Next, the mail checking part 5 determines whether or not the electronic mail apparatus 1 is operated in accordance with an instruction of a computer virus from the verification result of the security apparatus 7 (Step S2). In the case of determining that the electronic mail apparatus 1 is operated in accordance with an instruction of a computer virus, the mail checking part 5 completes the processing without transmitting an electronic mail. In the case of determining that the electronic mail apparatus 1 is not operated in accordance with an instruction of a computer virus, the mail checking part 5 performs Step S3.

In Step S3, the mail checking part 5 displays the contents of an electronic mail to be transmitted, such as a summary, a subject, a transmission destination, and the like, on a screen of the display apparatus 11 connected to the electronic mail apparatus 1. Furthermore, at this time, the mail checking part 5 requests the user to input authentication information so as to allow the personal identification authenticating part 6 to authenticate personal identification (Step S4).

Then, the mail checking part 5 determines whether or not it has received a response to the effect that the user is identified from the personal identification authenticating part 6 (Step S5). In the case where the mail checking part 5 has not received the response to the effect that the user is identified, the mail checking part 5 completes the processing without transmitting an electronic mail.

On the other hand, in the case where the mail checking part 5 has received the response to the effect that the user is identified, the mail checking part 5 displays a message on the screen of the display apparatus 11 so as to request the user to confirm whether or not the user intends to transmit an electronic mail (Step S6)

Then, the mail checking part 5 determines whether or not it has received a response to the effect that the electronic mail is intended to be transmitted by the user, based on an input signal input by the user from the input device (not shown) (Step S7).

In the case where the mail checking part 5 has received the response to the effect that the electronic mail is intended to be transmitted by the user, the mail checking part 5 completes the processing by transmitting the electronic mail to the mail server 12 (Step S8). On the other hand, in the case where the mail checking part 5 has not received the response to the effect that the use is identified and the response to the effect that the electronic mail is intended to be transmitted by the user, the mail checking part 5 completes the processing without transmitting the electronic mail.

In Embodiment 1, after the completion of the processing, the mail checking part 5 saves the result showing whether or not the mail checking part 5 has transmitted the electronic mail in a storage apparatus of the PC or the like as a log. It is preferable that the region where a log is saved is encoded by the security apparatus 7 so as to prevent a virus from tampering a log.

As described above, according to the electronic mail apparatus, the electronic mail system, and the electronic mail transmission method according to Embodiment 1, even in the case where a pattern file corresponding to a new computer virus is not present, and even in the case where a pattern file has not been updated due to a human mistake, the illegal mail transmission preventing part 10 can prevent an electronic mail from being transmitted by a computer virus. Furthermore, an electronic mail can also be prevented from being transmitted against the intension of the user by a third party other than the user.

Furthermore, in Embodiment 1, the security apparatus 7 monitors whether or not the programs constituting respective parts such as the mail checking part 7 and the personal identification authenticating part 6 have been tampered by a computer virus. Therefore, an illegal electronic mail can be prevented from being transmitted with a very high probability.

### Embodiment 2

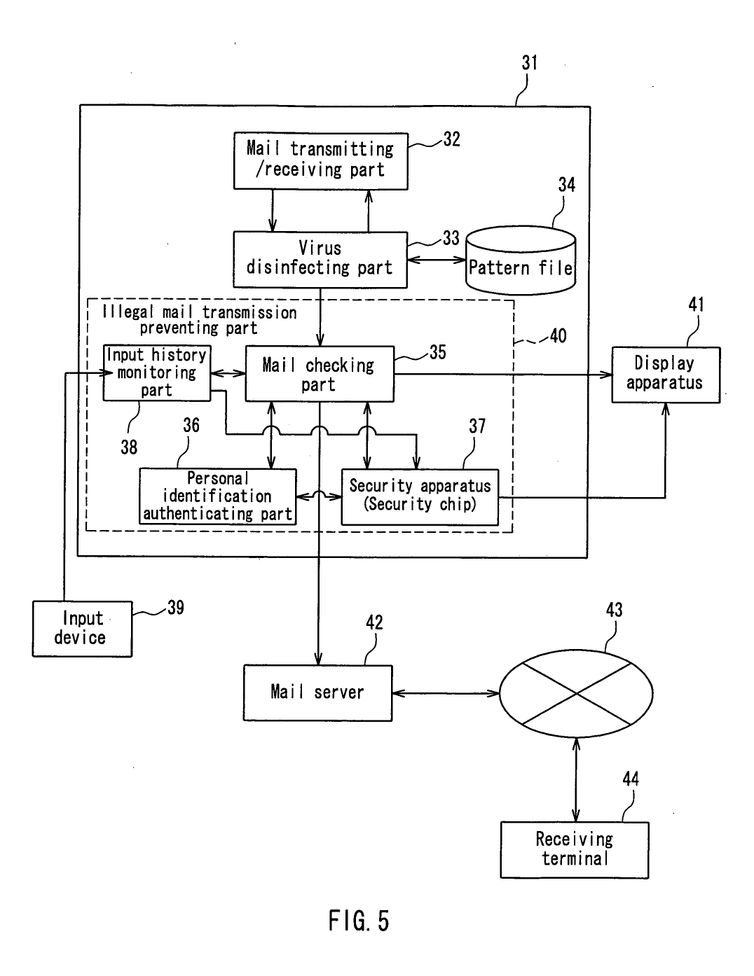

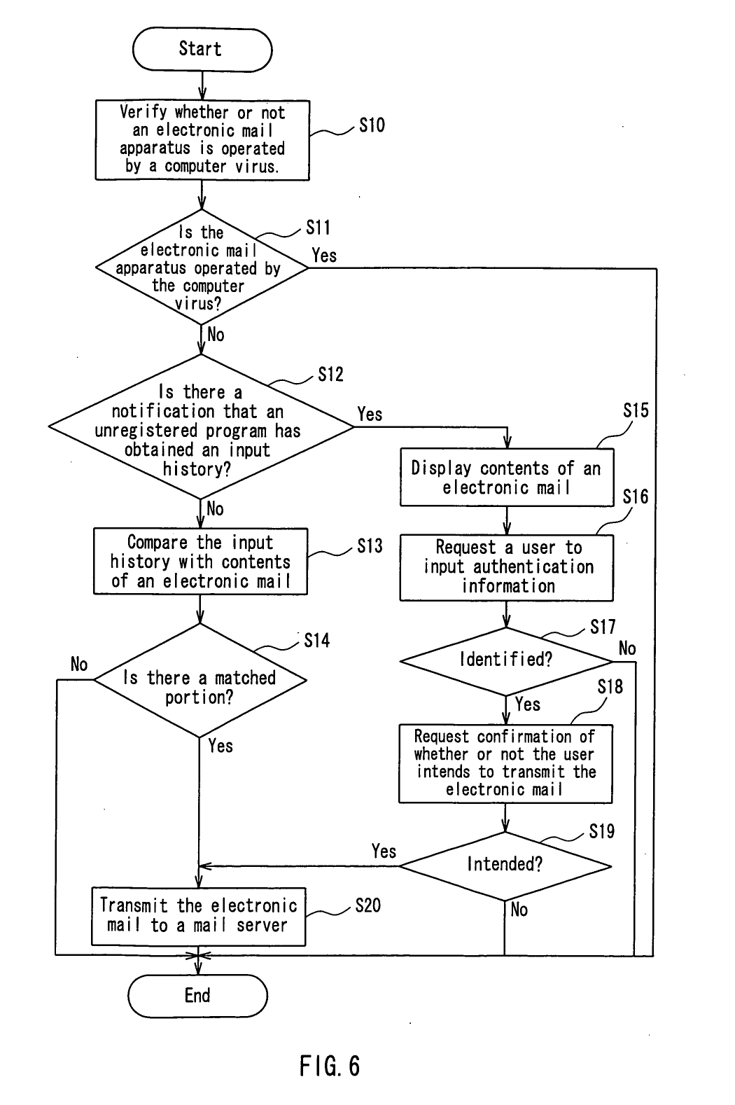

Hereinafter, an electronic mail apparatus, an electronic mail system, and an electronic mail transmission method according to Embodiment 2 of the present invention will be described with reference to FIGS. 5 and 6. First, configurations of the electronic mail apparatus and the electronic mail system according to Embodiment 2 of the present invention will be described with reference to FIG. 5.

FIG. 5 is a diagram showing configurations of the electronic mail apparatus and the electronic mail system according to Embodiment 2 of the present invention. As shown in FIG. 5, even in Embodiment 2, the electronic mail system includes an electronic mail apparatus 31 and a mail server 42 in the same way as in Embodiment 1. The electronic mail apparatus 31 includes a mail transmitting/receiving part 32, a virus disinfecting part 33, and an illegal mail transmission preventing part 40.

Furthermore, even in Embodiment 2, the electronic mail apparatus 31 is composed of a PC, and the mail transmitting/receiving part 32, the virus disinfecting part 33, and the mail server 42 are the same as those in Embodiment 1. The mail server 42 is connected to the Internet 43.

In Embodiment 2, the processing in the illegal mail transmission preventing part 40 is different from that in Embodiment 1. In Embodiment 2, the illegal mail transmission preventing part 40 includes an input history monitoring part 38 in addition to a mail checking part 35, a personal identification authenticating part 36, and a security apparatus 37.

The mail checking part 35 determines whether or not an electronic mail is an illegal one caused by a computer virus in the same way as in Embodiment 1. In Embodiment 2, the mail checking part 35 performs this determination using the input history monitoring part 38. The input history monitoring part 38 has a function of obtaining information (hereinafter, referred to as “input history information”) for specifying a sentence and the like (input history) input from an input device 39 such as a keyboard when a user creates an electronic mail, and storing the information in a memory in the security apparatus 37.

More specifically, the mail checking part 35 compares the input history specified by the input history information stored in the security apparatus 37 with the contents of the electronic mail. As a result of the comparison, in the case where an entirety or a part of sentences constituting the electronic mail is matched with the input history specified by the input history information, the mail checking part 35 determines that the electronic mail is not an illegal one, and transmits the electronic mail to the mail server 42. On the other hand, in the case where the entirety or the part of the sentences is not matched with the input history, the mail checking part 35 determines that the electronic mail is an illegal one, and stops the transmission of the electronic mail.

Furthermore, in Embodiment 2, the input history monitoring part 38 also has a function of monitoring the acquisition of input history information by a computer virus. More specifically, a program for obtaining input history information is previously registered in the input history monitoring part 38, and the input history monitoring part 38 monitors whether or not an unregistered program has obtained input history information.

As a result of the monitoring, in the case where an unregistered program has obtained input history information, the input history monitoring part 38 notifies the mail checking part 35 that the unregistered program has obtained input history information. The mail checking part 35 notified of this stops determination using the input history monitoring part 38, and switches to the determination using the personal identification authenticating part 36 in the same way as in Embodiment 1.

Next, operations of the electronic mail apparatus and the electronic mail system according to Embodiment 2 of the present invention will be described with reference to FIG. 6. FIG. 6 is a flow chart showing mail transmission processing in the electronic mail apparatus according to Embodiment 2 of the present invention. The electronic mail transmission method according to Embodiment 2 is also performed by operating the electronic mail apparatus and the electronic mail system according to Embodiment 2.

As shown in FIG. 6, first, the mail checking part 35 performs Steps S10 and S11. Steps S10 and S11 are similar to Steps S1 and S2 shown in FIG.4.

In Step S11, in the case where it is determined from the verification result of the security apparatus 37 that the electronic mail apparatus 31 is operated in accordance with an instruction of a computer virus, the mail checking part 35 completes the processing without transmitting an electronic mail. In the case where it is determined that the electronic mail apparatus 31 is not operated in accordance with an instruction of a computer virus, the mail checking part 35 performs Step S12.

In Step S12, the mail checking part 35 confirms whether or not it has been notified by the input history monitoring part 38 that an unregistered program has obtained input history information.

In the case where the mail checking part 35 has received the notification, the mail checking part 35 performs Steps S15 to S19 so as to determine whether or not the electronic mail is an illegal one using the personal identification authenticating part 36. In Step S19, in the case where the mail checking part 35 has received a response to the effect that the electronic mail is intended to be transmitted by a user, the mail checking part transmits the electronic mail to the mail server 42 and completes processing (Step S20). Steps S15 to S19 are respectively similar to Steps S3 to S7 shown in FIG. 4.

On the other hand, in the case where the mail checking part 35 has not received the notification, the mail checking part 35 compares the input history information stored in the security apparatus 37 by the input history monitoring part 38 with the contents of the electronic mail (Step S13), and determines whether or not an entirety or a part of sentences constituting an electronic mail is matched with an input history specified by the input history information (Step S14). More specifically, it is determined whether or not there is a portion in the sequence of character codes contained in the input history information, which is matched with the sequence of character codes in a body of an electronic mail.

As a result of the determination, in the case where the entirety or the part of the contents of the electronic mail is matched with the input history, the mail checking part 35 transmits the electronic mail to the mail server 42 and completes the processing (Step S20). On the other hand, in the case where it is determined that the entirety or the part of the contents of the electronic mail is not matched with the input history, the mail checking part 35 completes the processing without transmitting the electronic mail.

Even in Embodiment 2, after the completion of the processing, the mail checking part 35 saves the result showing whether or not the electronic mail has been transmitted in a storage apparatus or the like of a PC as a log.

As described above, the electronic mail apparatus, the electronic mail system, and the electronic mail transmission method according to Embodiment 2 also prevent a computer virus from transmitting an electronic mail in the same way as in Embodiment 1. Furthermore, in Embodiment 2, personal identification is authenticated if required, so that the convenience in the user can be enhanced.

### Embodiment 3

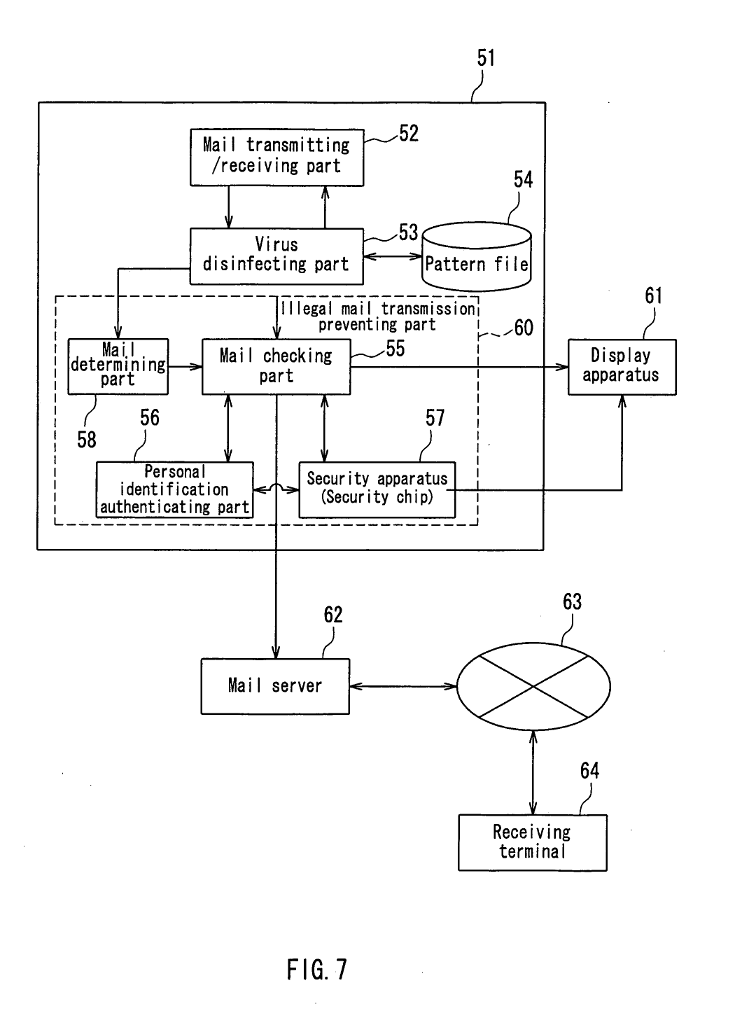

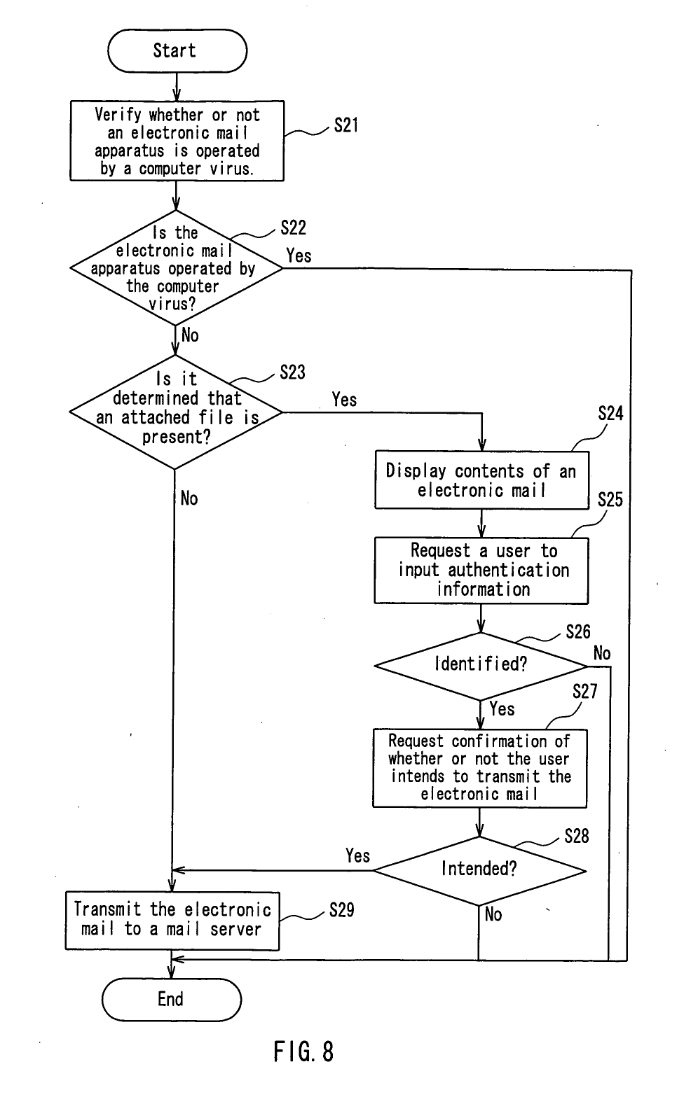

Next, an electronic mail apparatus, an electronic mail system, and an electronic mail transmission method according to Embodiment 3 of the present invention will be described with reference to FIGS. 7 and 8. First, configurations of the electronic mail apparatus and the electronic mail system according to Embodiment 3 of the present invention will be described with reference to FIG. 7.

FIG. 7 shows configurations of the electronic mail apparatus and the electronic mail system according to Embodiment 3 of the present invention. As shown in FIG. 7, even in Embodiment 3, in the same way as in Embodiment 1, the electronic mail system includes an electronic mail apparatus 51 and a mail server 62. The electronic mail apparatus 51 includes a mail transmitting/receiving part 52, a virus disinfecting part 53, and an illegal mail transmission preventing part 60.

Furthermore, even in Embodiment 3, the electronic mail apparatus 51 is composed of a PC, and the mail transmitting/receiving part 52, the virus disinfecting part 53, and the mail server 62 are similar to those in Embodiment 1. The mail server 62 is connected to the Internet 63.

In Embodiment 3, the processing in the illegal mail transmission preventing part 60 is different from that of Embodiment 1. In Embodiment 3, the illegal mail transmission preventing part 60 includes a mail determining part 58 in addition to a mail checking part 55, a personal identification authenticating part 56, and a security apparatus 57.

The mail checking part 55 determines whether or not an electronic mail is an illegal one caused by a computer virus. In Embodiment 3, this determination is performed using the mail determining part 58.

The mail determining part 58 determines whether or not an attached file is present in an electronic mail, and notifies the mail checking part 55 of a determination result. More specifically, in the case where the mail determining part 58 determines that an attached file is not present, the mail checking part 55 determines that the electronic mail is not an illegal one, and transmits it to the mail server 62. This is because an electronic mail transmitted by a computer virus is often accompanied by an attached file. On the other hand, in the case where the mail determining part 58 determines that an attached file is present, the mail checking part 55 determines whether or not the electronic mail is an illegal one using the personal identification authenticating part 56 in the same way as in Embodiment 1.

Next, operations of the electronic mail apparatus and the electronic mail system according to Embodiment 3 of the present invention will be described with reference to FIG. 8. FIG. 8 is a flow chart showing mail transmission processing in the electronic mail apparatus according to Embodiment 3 of the present invention. The electronic mail transmission method according to Embodiment 3 is also performed by operating the electronic mail apparatus and the electronic mail system according to Embodiment 3.

As shown in FIG. 8, first, the mail checking part 55 performs Steps S21 and S22. Steps S21 and S22 are the same as Steps S1 and S2 shown in FIG. 4.

In Step S22, in the case where it is determined from the verification result of the security apparatus 57 that the electronic mail apparatus 51 is operated in accordance with an instruction of a computer virus, the mail checking part 55 completes the processing without transmitting an electronic mail. In the case where it is determined that the electronic mail apparatus 51 is not operated in accordance with an instruction of a computer virus, the mail checking part 55 performs Steps S23.

In Step S23, the mail checking part 55 confirms a determination result notified from the mail determining part 58. In the case where the mail determining part 58 determines that an attached file is not present, the mail checking part 55 determines that the electronic mail is not an illegal one, and transmits the electronic mail to the mail server 62 to complete the processing (Step S29).

On the other hand, in the case where the mail determining part 58 determines that an attached file is present, the mail checking part 55 performs Steps S24 to S28 using the personal identification authenticating part 56. In Step S28, in the case where a user has received a response to the effect that the electronic mail is intended to be transmitted by the user, the mail checking part 55 transmits the electronic mail to the mail server 62 to complete the processing (Step S29).

Steps S24 to S28 are respectively similar to Steps S3 to S7 shown in FIG. 4. Even in Embodiment 3, after the completion of the processing, the mail checking part 35 saves a result showing whether or not the electronic mail has been transmitted in a storage apparatus of the PC or the like as a log.

As described above, an electronic mail is prevented from being transmitted by a computer virus in the same way as in Embodiment 1, even by the electronic mail apparatus, the electronic mail system, and the electronic mail transmission method according to Embodiment 3. Furthermore, even in Embodiment 3, the personal identification is authenticated if required, so that the convenience in the user can be enhanced.

### Embodiment 4

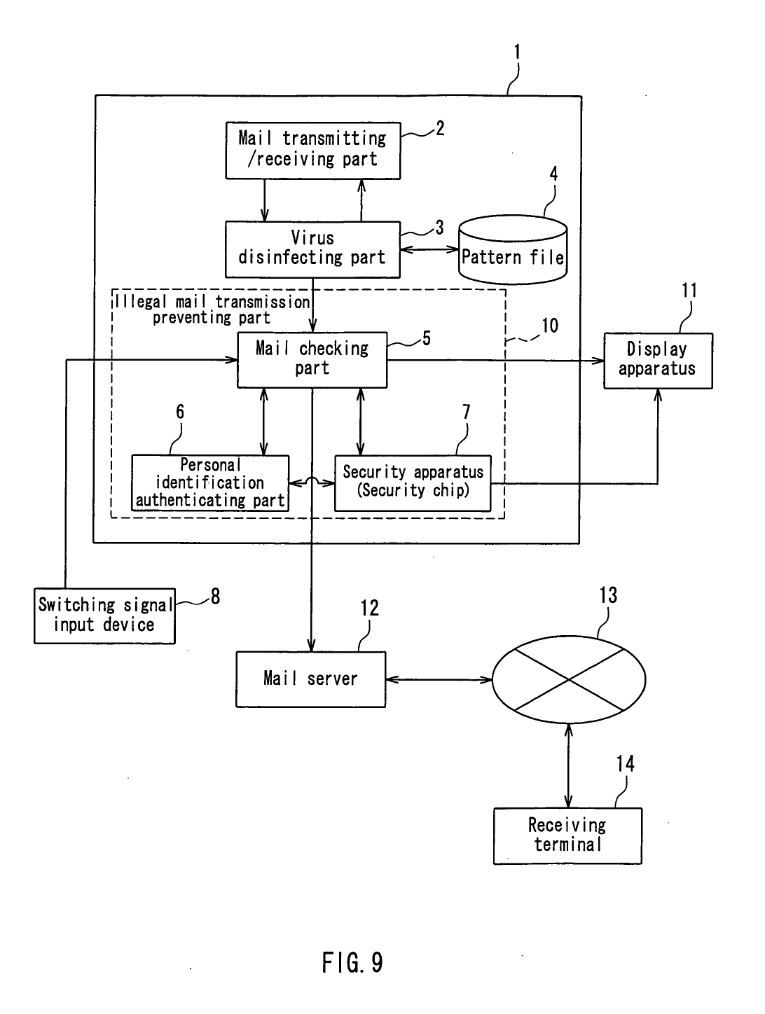

Next, an electronic mail apparatus, an electronic mail system, and an electronic mail transmission method according to Embodiment 4 of the present invention will be described with reference to FIG. 9. FIG. 9 shows configurations of the electronic mail apparatus and the electronic mail system according to Embodiment 4 of the present invention. The electronic mail transmission method according to Embodiment 4 is also performed by operating the electronic mail apparatus and the electronic mail system according to Embodiment 4.

As shown in FIG. 9, Embodiment 4 is different from Embodiment 1 in that a switching signal input device 8 in an external portion is connected to the mail checking part 5. The electronic mail apparatus and the electronic mail system according to Embodiment 4 are configured in the same way as in Embodiment 1 except for the above.

The switching signal input device 8 outputs a signal for instructing the mail checking part 5 to switch its operation. Therefore, a user can switch the operation in the mail checking part 5 by operating the switching signal input device 8.

For example, in the case where the electronic mail apparatus 1 is connected to a corporate intranet or the like, and a firewall or the like is constructed on the intranet, there may be a low possibility that the electronic mail apparatus 1 is attacked by a virus.

Thus, in such a case, the user can also instruct the mail checking part 5 to transmit all the electronic mails without requesting the authentication of personal identification and confirmation, using the switching signal input device 8.

On the other hand, in the case where the electronic mail apparatus 1 is connected to a general household telephone line or the like, there may be a high possibility that the electronic mail apparatus 1 is attacked by a virus. Thus, in such a case, the user can also instruct the mail checking part 5 to request the authentication of personal identification and confirmation with respect to all the electronic mails, using the switching signal input device 8. Furthermore, the user can also instruct the mail checking part 5 to stop transmitting all the electronic mails, using the switching signal input device 8.

As described above, according to the electronic mail apparatus, the electronic mail system, and the electronic mail transmission method according to Embodiment 4, the convenience in the user can be enhanced while the same effect as that in Embodiment 1 is obtained.

### Embodiment 5

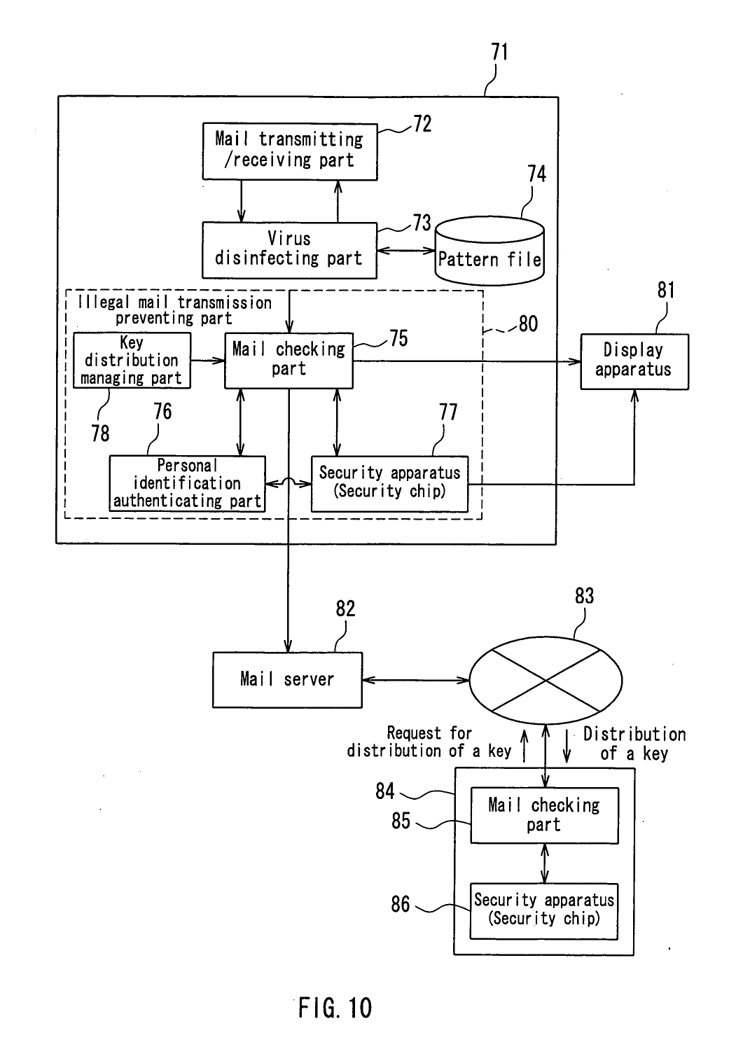

An electronic mail apparatus, an electronic mail system, and an electronic mail transmission method according to Embodiment 5 of the present invention will be described with reference to FIGS. 10 to 12. First, configurations of the electronic mail apparatus and the electronic mail system according to Embodiment 5 of the present invention will be described with reference to FIG. 10.

FIG. 10 shows configurations of the electronic mail apparatus and the electronic mail system according to Embodiment 5 of the present invention. As shown in FIG. 10, even in Embodiment 5, in the same way as in Embodiment 1, the electronic mail system includes an electronic mail apparatus 71 and a mail server 82. The electronic mail apparatus 71 includes a mail transmitting/receiving part 72, a virus disinfecting part 73, and an illegal mail transmission preventing part 80.

Furthermore, even in Embodiment 5, the electronic mail apparatus 71 is composed of a PC, and the mail transmitting/receiving part 72, the virus disinfecting part 73, and the mail server 82 are similar to those in Embodiment 1. The mail server 82 is connected to the Internet 83.

In Embodiment 5, the processing in the illegal mail transmission preventing part 80 is different from that in Embodiment 1. In Embodiment 5, the CPU of the security apparatus 77 can perform encoding processing and decoding processing in addition to the verification described in Embodiment 1. The CPU of the security apparatus 77 can also generate and save a public key used for encoding and a secret key used for decoding.

More specifically, in Embodiment 5, the security apparatus 77 has a function of generating and saving keys for encoding an electronic mail scheduled to be transmitted and for decoding the encoded electronic mail. Furthermore, the encoding by the security apparatus 77 can also be performed with respect to an attached file as well as an electronic mail body, in the case where the attached file is present.

Furthermore, the security apparatus 77 can also perform encoding processing and decoding processing with respect to keys for decoding an electronic mail, and can also generate and save a key required in this case.

Furthermore, the illegal mail transmission preventing part 80 includes a key distribution managing part 78 in addition to a mail checking part 75, a personal identification authenticating part 76, and a security apparatus 77. In the case where the receiving terminal 84 requests the distribution of a key for decoding an electronic mail encoded by the security apparatus, the key distribution managing part 78 determines whether or not to admit the distribution of the key.

The determination of whether or not the key is distributed can be performed, for example, by comparing the mail address of a transmission destination contained in the transmitted electronic mail with the mail address of the receiving terminal requesting the distribution of the key. In this case, when they are matched, the key distribution managing part 78 admits the distribution, and when they are not matched, the key distribution managing part 78 does not admit the distribution.

Furthermore, the determination of whether or not the key is distributed can also be performed based on the domain name of the mail address of the receiving terminal requesting the distribution of the key. In this case, the key distribution managing part 78 admits the distribution of the key only in the case where there is a request from the receiving terminal at the mail address having a previously registered domain name, and otherwise, does not admit the distribution. Examples of the previously registered domain include a domain name of an in-house mail and the like.

Therefore, in Embodiment 5, the mail checking part 75 determines whether or not the electronic mail is an illegal one caused by a computer virus. Thereafter, in the case of determining that the electronic mail is not an illegal one, the mail checking part 75 allows the security apparatus 77 to encode the electronic mail, and transmits the encoded electronic mail to the mail server 82.

Furthermore, in the case where the a receiving terminal (another electronic mail apparatus) 84 that has received the encoded electronic mail requests the transmission of a key for decoding, the mail checking part 75 distributes the key in accordance with the determination of the key distribution managing part 78.

In Embodiment 5, the receiving terminal 84 is an electronic mail apparatus configured in the same way as in the electronic mail apparatus 71. In FIG. 10, regarding the receiving terminal 84, only a mail checking part 85 and a security apparatus 86 are shown. The receiving terminal 84 is not limited to the one configured in the same way as in the electronic mail apparatus 71, and may be any apparatus capable of requesting the distribution of a key for decoding and decoding an electronic mail by the distributed key.

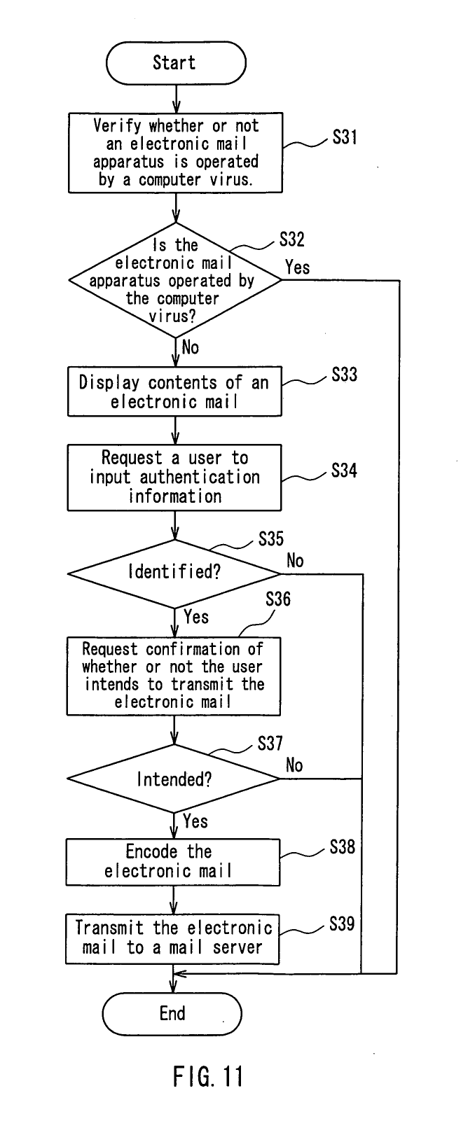

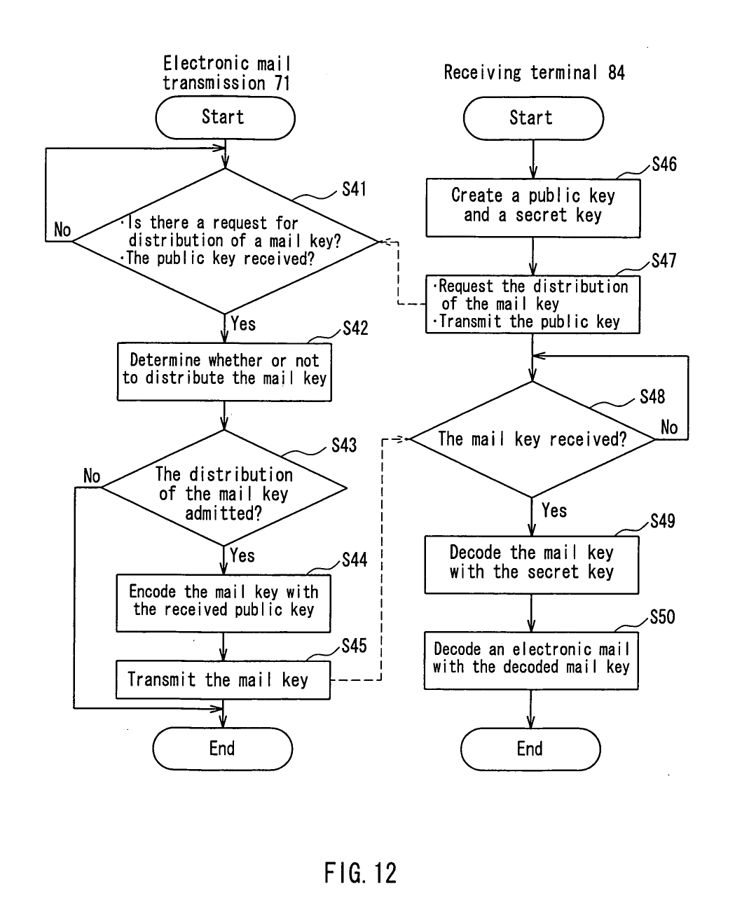

Next, operations of the electronic mail apparatus and the electronic mail system according to Embodiment 5 of the present invention will be described with reference to FIGS. 11 and 12. FIG. 11 is a flow chart showing mail transmission processing in the electronic mail apparatus according to Embodiment 5 of the present invention. FIG. 12 is a flow chart showing processing of decoding an electronic mail in the electronic mail system according to Embodiment 5 of the present invention. The electronic mail transmission method according to Embodiment 5 is also performed by operating the electronic mail apparatus and the electronic mail system according to Embodiment 5.

As shown in FIG. 11, first, the mail checking part 85 performs Steps S31 to S35. Steps S31 to S37 are similar to Steps S1 to S7 shown in FIG. 4. In Step S37, in the case of receiving a response to the effect that an electronic mail is intended to be transmitted by a user, the mail checking part 85 allows the security apparatus 77 to encode the electronic mail (Step S38). Thereafter, the mail checking part 5 transmits the encoded electronic mail to the mail server 82 to complete the processing (Step S39). Even in Embodiment 5, after the completion of the processing, the mail checking part 85 saves a result showing whether or not the electronic mail has been transmitted in a storage apparatus of the PC or the like as a log.

When the electronic mail apparatus 71 transmits the encoded electronic mail in Step S37, in the electronic mail apparatus 71 and the receiving terminal 84, the processing shown in FIG. 12 is performed as described below.

As shown in FIG. 12, when the receiving terminal 84 receives the encoded electronic mail, the mail checking part 85 of the receiving terminal 84 allows the security apparatus 86 to create a public key and a secret key (Step S46). The public key is used for encoding processing of a key (hereinafter, referred to as a “mail key”) for decoding an electronic mail from the electronic mail apparatus 71, and the secret key is used for decoding a mail key.

Thereafter, the mail checking part 85 of the receiving terminal 84 obtains a public key and a secret key created in Step S46 from the security apparatus 86, requests the electronic mail apparatus 71 to distribute a mail key, and transmits a public key for encoding the mail key (Step S47).

Next, in the electronic mail apparatus 71, the mail checking part 75 confirms whether or not there is a request for distributing a mail key from the receiving terminal 84, and whether or not the receiving terminal has received a public key for encoding the mail key (Step S41).

In the case where the receiving terminal 84 requests the distribution of the mail key, or has received the public key, the mail checking part 75 allows the key distribution managing part 78 to determine whether or not to admit the distribution of the mail key (Step S42), and confirms a determination result (Step S43).

In the case where the key distribution managing part 78 determines not to admit the distribution of the mail key, the mail checking part 45 completes the processing. On the other hand, in the case where the key distribution managing part 78 determines to admit the distribution of the mail key, the mail checking part 75 uses the public key received in Step S41 to allow the security apparatus 77 to encode the mail key (Step S44).

When Step S44 is performed, the mail checking part 75 obtains the encoded mail key from the security apparatus 77, and transmits it to the mail server 82 (Step S45). Thereafter, the mail server 82 transmits the encoded mail key to the receiving terminal 84 via the Internet 83.

After performing Step S47, in the receiving terminal 84, the mail checking part 85 confirms whether or not the mail key has been transmitted from the electronic mail apparatus 71 (Step S48). In the case where the receiving terminal has received the mail key, the mail checking part 85 decodes the mail key with the secret key created in Step S46 (Step S49).

When Step S49 is performed, the mail checking part 85 decodes the encoded electronic mail with the decoded mail key (Step S50). The decoded electronic mail is displayed on a display apparatus (not shown) connected to the receiving terminal 84. Thus, the processing in the electronic mail apparatus 71 and the receiving terminal 84 is completed.

As described above, an illegal electronic mail can be prevented from being transmitted by a computer virus in the same way as in Embodiment 1 even by the electronic mail apparatus, the electronic mail system, and the electronic mail transmission method according to Embodiment 5. Furthermore, in Embodiment 5, even in the case where an illegal electronic mail is transmitted by mistake, the outflow of information can be prevented by distributing no mail key.

### Embodiment 6

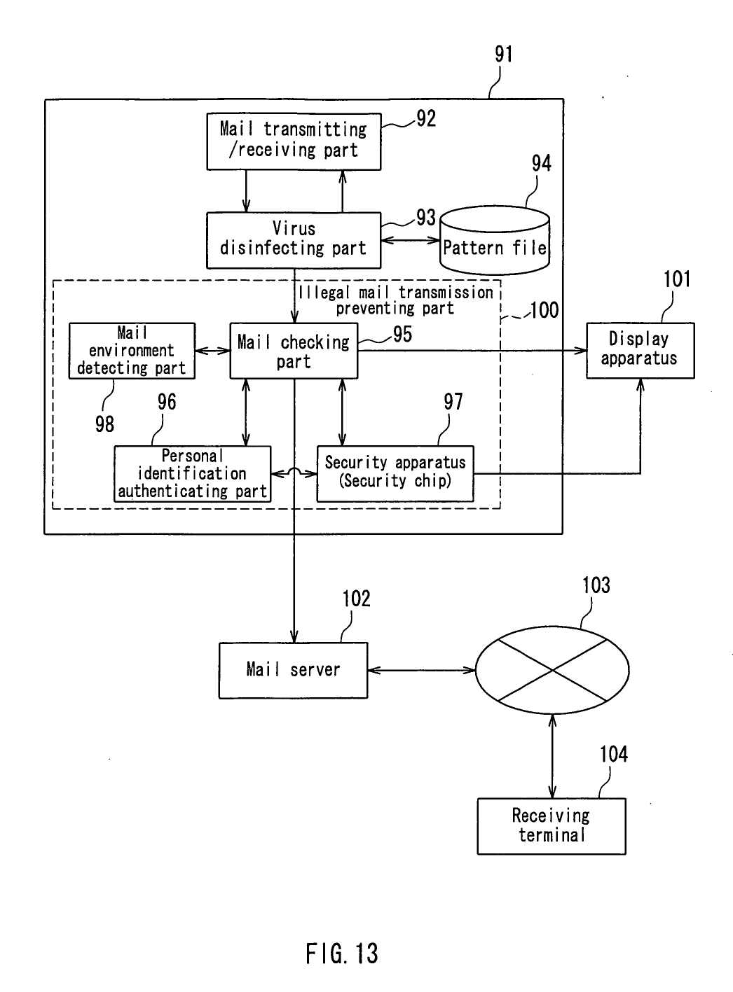

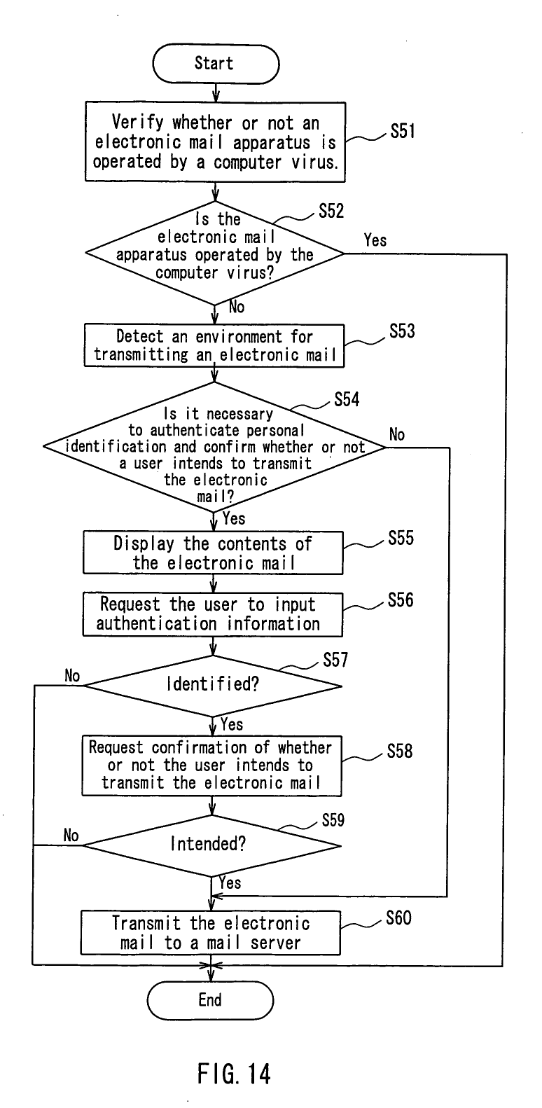

Next, an electronic mail apparatus, an electronic mail system, and an electronic mail transmission method according to Embodiment 6 of the present invention will be described with reference to FIGS. 13 and 14. First, configurations of the electronic mail apparatus and the electronic mail system according to Embodiment 6 of the present invention will be described with reference to FIG. 13.

FIG. 13 shows configurations of the electronic mail apparatus and the electronic mail system according to Embodiment 6 of the present invention. As shown in FIG. 13, even in Embodiment 6, in the same way as in Embodiment 1, the electronic mail system includes an electronic mail apparatus 91 and a mail server 102. The electronic mail apparatus 91 includes a mail transmitting/receiving part 92, a virus disinfecting part 93, and an illegal mail transmission preventing part 100.

Furthermore, even in Embodiment 6, the electronic mail apparatus 91 is composed of a PC, and the mail transmitting/receiving part 92, the virus disinfecting part 93, and the mail server 102 are similar to those in Embodiment 1. The mail server 102 is connected to the Internet 103.

Embodiment 6 is different from Embodiment 1 in the processing in the illegal mail transmission preventing part 100. In Embodiment 6, the illegal mail transmission preventing part 100 includes a mail environment detecting part 98 in addition to a mail checking part 95, a personal identification authenticating part 96, and a security apparatus 97. The mail environment detecting part 98 has a function of detecting the environment for transmitting an electronic mail, and notifying the mail checking part 95 of a detection result.

More specifically, the environment for transmitting an electronic mail refers to a communication path between the electronic mail apparatus 91 and the receiving terminal 104. The mail environment detecting part 98 notifies the mail checking part 95 of, for example, whether or not the mail server 102 used by the electronic mail apparatus 91 and the mail server (not shown) used by the receiving terminal 104 are identical or connected to the same intranet, i.e., whether or not an electronic mail is an in-house mail, whether or not a virus disinfection program is operated in the mail server 102, etc. as a detection result.

The detection of an environment for transmitting an electronic mail by the mail environment detecting part 98, e.g., the detection of whether or not an electronic mail is an in-house mail can be performed by registering a domain name in the case of an in-house mail in the mail environment detecting part 98.

Furthermore, in Embodiment 6, in order to detect whether or not a virus disinfection program is operated in the mail server 102, a program for notifying the electronic mail apparatus 91 that the virus disinfection program is operated is executed on the mail server 102.

Therefore, in Embodiment 6, the mail checking part 95 determines whether or not to request the authentication of personal identification and the confirmation described in Embodiment 1, with respect to a user, based on the detection result from the mail environment detecting part 98. For example, in the case where an electronic mail transmitted from the electronic mail apparatus 91 is an in-house mail, and in the case where a virus disinfection program is operated in the mail server 102, there may be a low possibility that the electronic mail apparatus 91 is attacked by a virus. Thus, in this case, the mail checking part 95 can transmit an electronic mail without requesting the authentication of personal identification and the confirmation described in Embodiment 1.

Next, operations of the electronic mail apparatus and the electronic mail system according to Embodiment 6 of the present invention will be described with reference to FIG. 14. FIG. 14 is a flow chart showing mail transmission processing in the electronic mail apparatus in Embodiment 3 of the present invention. The electronic mail transmission method according to Embodiment 6 is also performed by operating the electronic mail apparatus and the electronic mail system according to Embodiment 6.

As shown in FIG. 14, first, the mail checking part 95 performs Steps S51 and S52. Steps S51 and S52 are similar to Steps S1 and S2 shown in FIG. 4.

In Step S52, in the case of determining that the electronic mail apparatus 91 is operated in accordance with an instruction of a computer virus from the detection result of the security apparatus 97, the mail checking part 95 completes the processing without transmitting an electronic mail. In the case of determining that the electronic mail apparatus 91 is not operated in accordance with an instruction of a computer virus, the mail checking part 95 performs Step S53.

In Step S53, the mail checking part 95 allows the mail environment detecting part 98 to detect the environment for transmitting an electronic mail. Next, the mail environment detecting part 98 determines whether or not to request the authentication of personal identification and the confirmation of whether or not a user intends to transmit an electronic mail, with respect to the user, based on the notified detection result (Step S54).

In the case of determining not to request the authentication of personal identification and the confirmation, the mail checking part 95 transmits an electronic mail to the mail server 102 to complete the processing. On the other hand, in the case of determining to request the authentication of personal identification and the confirmation, the mail checking part 95 performs Steps S55 to S59. Steps S55 to S59 are similar to Steps S3 to S7 shown in FIG. 4.

In Step S59, in the case of receiving a response to the effect that an electronic mail is intended to be transmitted by a user, the mail checking part 95 transmits the electronic mail to the mail server 102 to complete the processing (Step S60). In the case of not receiving a response to the effect that an electronic mail is intended to be transmitted by the user, the mail checking part 95 completes the processing without transmitting the electronic mail. Even in Embodiment 6, after the completion of the processing, the mail checking part 95 saves a result showing whether or not the electronic mail has been transmitted in a storage apparatus of the PC or the like as a log.

As described above, an electronic mail can be prevented from being transmitted by a computer virus in the same way as in Embodiment 1 even by the electronic mail apparatus, the electronic mail system, and the electronic mail transmission method according to Embodiment 6. Furthermore, even in Embodiment 6, personal identification is authenticated if required, so that the convenience in the user can be enhanced.

### Embodiment 7

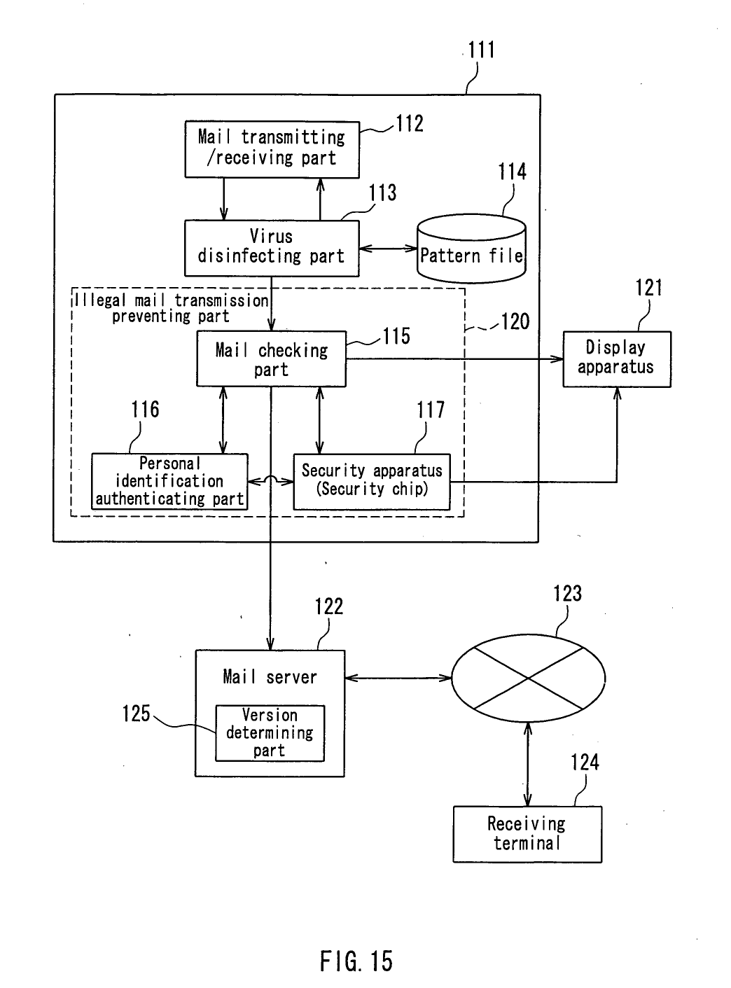

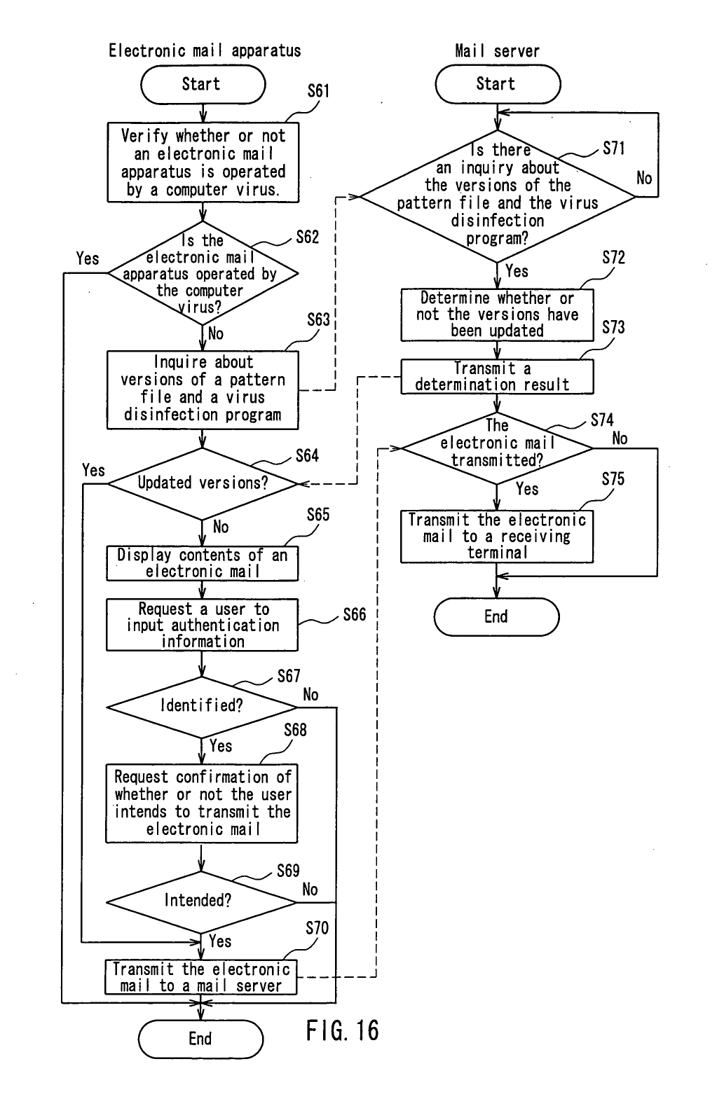

Next, an electronic mail apparatus, an electronic mail system, and an electronic mail transmission method according to Embodiment 7 of the present invention will be described with reference to FIGS. 15 and 16. First, configurations of the electronic mail apparatus and the electronic mail system according to Embodiment 7 of the present invention will be described with reference to FIG. 15.

FIG. 15 shows configurations of the electronic mail apparatus and the electronic mail system according to Embodiment 7 of the present invention. As shown in FIG. 15, even in Embodiment 7, in the same way as in Embodiment 1, the electronic mail system includes an electronic mail apparatus 111 and a mail server 122. The electronic mail apparatus 111 includes a mail transmitting/receiving part 112, a virus disinfecting part 113, and an illegal mail transmission preventing part 120.

Furthermore, the illegal mail transmission preventing part 120 includes a mail checking part 115, a personal identification authenticating part 116, and a security apparatus 117. Furthermore, the electronic mail apparatus 111 is composed of a PC, and the mail transmitting/receiving part 112 and the virus disinfecting part 113 are similar to those in Embodiment 1. The mail server 122 is connected to the Internet 123.

In Embodiment 7, the security apparatus 117 manages versions of a pattern file 114 and a virus disinfection program configuring the virus disinfecting part 113 in addition to the verification of whether or not the electronic mail apparatus 111 is operated in accordance with an instruction of a computer virus.

Furthermore, in Embodiment 7, the mail server 122 includes a version determining part 125. The version determining part 125 determines whether or not each version of the pattern file 114 and the virus disinfection program managed by the security apparatus 115 has been updated.

The mail server 122 stores information (updated version information) for specifying each updated version of the pattern file 114 and the virus disinfection program, and the version determining part 125 performs the determination based on the updated version information. Furthermore, the updated version information may be input by an administrator of the mail server 122, or may be information obtained when the mail server 122 accesses a Web site administered by a company of developing the virus disinfection program.

Furthermore, in the case where the version determining part 125 determines that any of the versions has not been updated, the mail server 122 notifies the electronic mail apparatus 111 that any of the versions has not been updated. In Embodiment 7, in the case of receiving this notification, the mail checking part 115 requests the authentication of personal identification and the confirmation of whether or not a user intends to transmit an electronic mail, with respect to the user.

In Embodiment 7, the security apparatus 117 can also manage the version of the electronic mail program configuring the mail transmitting/receiving part 112. Furthermore, the version determining part 125 can also determine whether or not the version of the electronic mail program has been updated.

Next, operations of an electronic mail apparatus and an electronic mail system according to Embodiment 7 of the present invention will be described with reference to FIG. 16. FIG. 16 is a flow chart showing mail transmission processing in the electronic mail system according to Embodiment 7 of the present invention. The electronic mail transmission method according to Embodiment 7 is also performed by operating the electronic mail apparatus and the electronic mail system according to Embodiment 7.

As shown in FIG. 16, first, the mail checking part 115 performs Steps S61 and S62. Steps S61 and S62 are similar to Steps S1 and S2 shown in FIG. 4.

In Step S62, in the case of determining that the electronic mail apparatus 111 is operated in accordance with a computer virus from the verification result of the security apparatus 117, the mail checking part 115 completes the processing without transmitting an electronic mail. In the case of determining that the electronic mail apparatus 111 is not operated in accordance with an instruction of a computer virus, the mail checking part 115 performs Step S63.

In Step S63, the mail checking part 115 inquires of the mail server 122 about the versions of the pattern file 114 and the virus disinfection program.

On the other hand, the mail server 122 monitors whether or not the electronic mail apparatus 111 inquires about each version of the pattern file 114 and the virus disinfection program (Step S71).

In the case where there is an inquiry, the mail server 122 determines by the version determining part 125 whether or not each version of the pattern file 114 and the virus disinfection program in the electronic mail apparatus 111 has been updated (Step S72), and transmits the determination result to the electronic mail apparatus 111 (Step S73).

After performing Step S63, the mail checking part 115 confirms the determination result transmitted in Step S73 (Step S64). In the case where any of the versions has been updated as a result of the confirmation, the mail checking part 115 transmits an electronic mail to the mail server 122 (Step S70).

On the other hand, in the case where any of the versions has not be updated as a result of the confirmation, the mail checking part 115 performs Steps S65 to S69. Steps S65 to S69 are similar to those in Steps S3 to S7 shown in FIG. 4.

In the case of having received a response to the effect that an electronic mail is intended to be transmitted by a user in Step S69, the mail checking part 115 transmits the electronic mail to the mail server 122 to complete the processing (Step S70). In the case of not having received a response to the effect that an electronic mail is intended to be transmitted by the user, the mail checking part 115 completes the processing without transmitting the electronic mail. Even in Embodiment 7, after the completion of the processing, the mail checking part 115 saves a result showing whether or not the electronic mail has been transmitted in a storage apparatus of the PC or the like as a log.

Furthermore, after transmitting the determination result in Step S73, the mail server 122 confirms whether or not it has received an electronic mail from the electronic mail apparatus 111 (Step S74). In the case of not having received the electronic mail, the mail server 122 completes the processing. In the case of having received an electronic mail, the mail server 122 transmits the electronic mail to the receiving terminal 124 to complete the processing (Step S75).

As described above, an electronic mail is prevented from being transmitted by a computer virus in the same way as in Embodiment 1 even by the electronic mail apparatus, the electronic mail system, and the electronic mail transmission method according to Embodiment 7. Furthermore, even in Embodiment 7, personal identification is authenticated if required, so that the convenience in the user can be enhanced.

Furthermore, in Embodiment 7, an electronic mail can be prevented from being transmitted from an electronic mail apparatus with an old pattern file, which can reduce the load in the detection of a virus at the receiving terminal and on the mail server.

### Embodiment 8

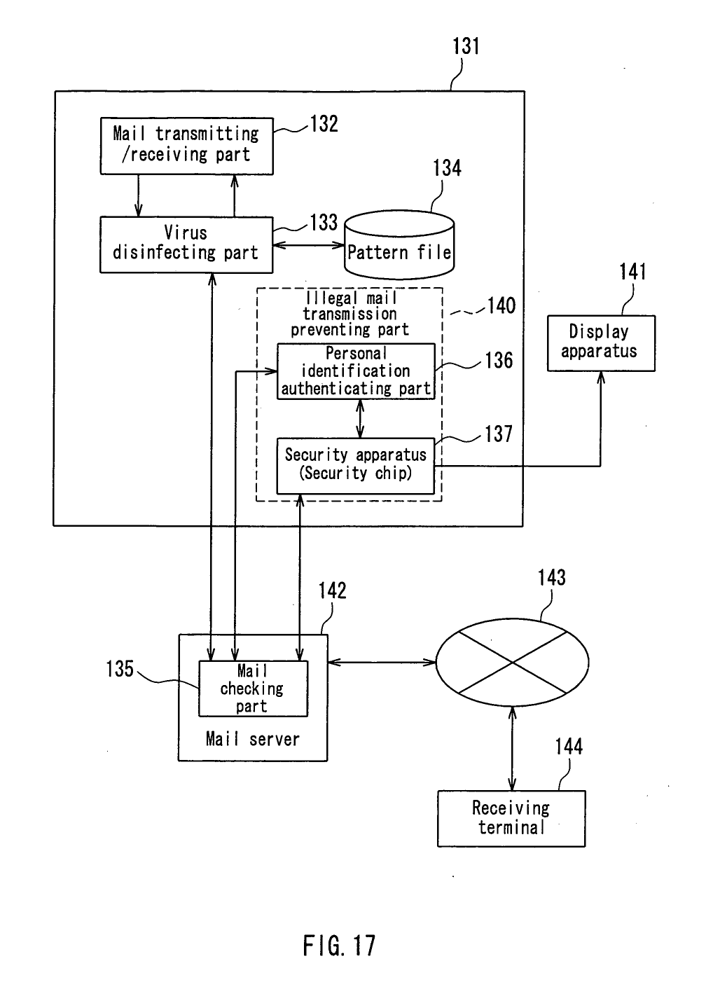

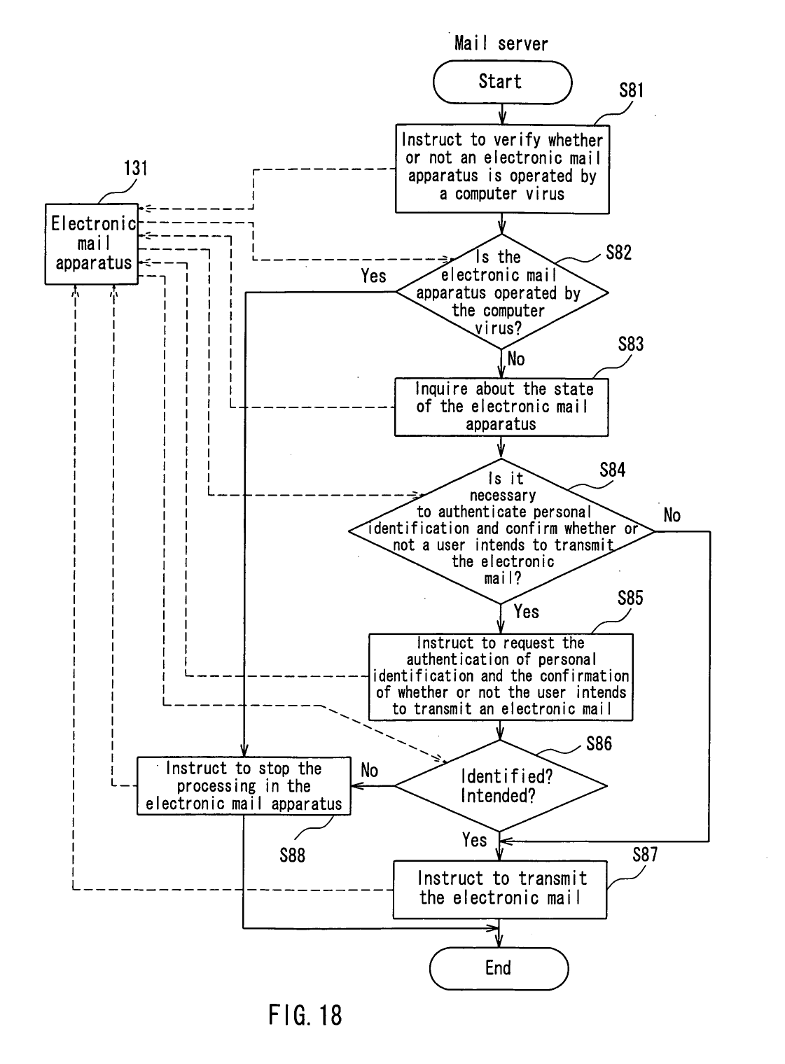

Next, an electronic mail apparatus, an electronic mail system, and an electronic mail transmission method according to Embodiment 8 of the present invention will be described with reference to FIGS. 17 and 18. First, configurations of the electronic mail apparatus and the electronic mail system according to Embodiment 8 of the present invention will be described with reference to FIG. 17. FIG. 17 shows configurations of the electronic mail apparatus and the electronic mail system according to Embodiment 8 of the present invention.

As shown in FIG. 17, in an electronic mail apparatus 131, a mail server 142, and an electronic mail system according to Embodiment 8, a mail checking part 135 is provided in the mail server 142.

Furthermore, unlike Embodiment 1, in Embodiment 8, a security apparatus 137 has a function of obtaining and managing information specifying the state of the electronic mail apparatus 131.

Examples of the information specifying the state of the electronic mail apparatus 131 include a version of a pattern file 134, a version of a virus disinfection program configuring a virus disinfecting part 133, a version of an electronic mail program configuring a mail transmitting/receiving part 132, a version of an OS incorporated in a PC, and the like.

Furthermore, the mail checking part 135 has a function similar to that of the mail checking part in Embodiment 1. In addition, the mail checking part 135 also has a function of inquiring of the security apparatus 137 about the state of the electronic mail apparatus 131, and making determination based on the transmitted information specifying the state of the electronic mail apparatus 131.

For example, in the case where each version of the pattern file 134, the virus disinfection program, and the electronic mail program is transmitted from the security apparatus 137 as an inquiry result, the mail checking part 135 determines whether or not they have been updated.

The electronic mail apparatus, the mail server, and the electronic mail system according to Embodiment 8 are configured in the same way as in Embodiment 1 except for the above.

Next, operations of the electronic mail apparatus and the electronic mail system according to Embodiment 8 of the present invention will be described with reference to FIG. 18. FIG. 18 is a flow chart showing mail transmission processing in a mail server of the electronic mail system according to Embodiment 8 of the present invention. The electronic mail transmission method according to Embodiment 8 is also performed by operating the electronic mail apparatus and the electronic mail system according to Embodiment 1.

As shown in FIG. 18, first, the mail checking part 135 provided in the mail server 142 instructs the security apparatus 137 of the electronic mail apparatus 131 to verify whether or not the electronic mail apparatus 131 is operated in accordance with an instruction of a computer virus (Step S81). The verification performed in accordance with the instruction in Step S81 is the same as that performed in Step S1 shown in FIG. 4.

Next, the mail checking part 135 determines whether or not the electronic mail apparatus 131 is operated in accordance with an instruction of a computer virus based on the verification result transmitted from the security apparatus 137 (Step S82).

In the case of determining that the electronic mail apparatus 1 is operated in accordance with an instruction of a computer virus, the mail checking part 135 instructs the electronic mail apparatus 131 to stop the processing (Step S88).

On the other hand, in the case of determining that the electronic mail apparatus 1 is not operated in accordance with an instruction of a computer virus, the mail checking part 135 inquires of the security apparatus 137 about the state of the electronic mail apparatus (Step S83). In Embodiment 8, the mail checking part 135 instructs the security apparatus 137 to transmit each version of the pattern file 134, the virus disinfection program, and the electronic mail program managed by the security apparatus 137.

Next, the mail checking part 135 determines whether or not the authentication of personal identification and the confirmation of whether or not a user intends to transmit an electronic mail are required based on the state of the electronic mail apparatus transmitted from the security apparatus 137 (Step S84). In Embodiment 8, each version of the pattern file 134, the virus disinfection program, and the electronic mail program managed by the security apparatus 137 is transmitted, so that the mail checking part 135 determines whether or not the authentication of personal identification and the confirmation are required by determining whether or not each version has been updated.

In the case of determining that the authentication of personal identification and the confirmation are not required, i.e., in the case of determining that all the versions of the pattern file 134, the virus disinfection program, and the electronic mail program have been updated, the mail checking part 135 instructs the mail transmitting/receiving part 132 to transmit an electronic mail (Step S87).

On the other hand, in the case of determining that the authentication of personal identification and the confirmation are required, i.e., in the case of determining that any of the versions of the pattern file 134, the virus disinfection program, and the electronic mail program has not been updated, the mail checking part 135 instructs the electronic mail apparatus 131 to request the authentication of personal identification and the confirmation of whether or not a user intends to transmit an electronic mail, with respect to the user (Step S85).

More specifically, the instructed mail checking part 135 displays the contents of an electronic mail to be transmitted, such as a summary, a subject, a transmission destination, and the like, on a screen of the display apparatus 141 connected to the electronic mail apparatus 131, and requests the input of authentication information and the input of confirmation of whether or not an electronic mail is intended to be transmitted.

Then, when having received the authentication result by the personal identification authenticating part 136 and the input result input from the input device (not shown) by the user, the mail checking part 135 determines whether or not it has received a response to the effect that the user is identified and a response to the effect that an electronic mail is intended to be transmitted by the user (Step S86).

In the case of having received a response to the effect that the user is identified, and a response to the effect that an electronic mail is intended to be transmitted by the user, the mail checking part 135 instructs the mail transmitting/receiving part 132 to transmit an electronic mail (Step S87). On the other hand, in the case of not having received a response to the effect that the user is identified and a response to the effect that an electronic mail is not intended to be transmitted, the mail checking part 135 instructs the electronic mail apparatus 131 to stop the processing (Step S88). Thus, the processing is completed.

As described above, an electronic mail is prevented from being transmitted by a computer virus in the same way as in Embodiment 1 even by the electronic mail apparatus, the electronic mail system, and the electronic mail transmission method according to Embodiment 8.

Furthermore, in Embodiment 8, the mail checking part is provided in the mail server, so that the configuration of the electronic mail apparatus can be simplified, or processing to be performed in the electronic mail apparatus can be reduced, so that the cost in the electronic mail apparatus can be reduced.

### INDUSTRIAL APPLICABILITY

As described above, an illegal electronic mail caused by a computer virus can be prevented from being transmitted against user's intention with a very high probability, compared with the conventional example, if the electronic mail apparatus, the electronic mail system, and the electronic mail transmission method according to the present invention are used. Therefore, high safety can be provided to a user.

1. An electronic mail apparatus capable of suppressing an illegal electronic mail from being transmitted by a computer virus, comprising a mail checking part for determining whether or not an electronic mail scheduled to be transmitted is an illegal electronic mail caused by the computer virus,
wherein, in a case of requesting authentication of personal identification with respect to a user and receiving a response to the effect that the user is identified, the mail checking part determines that the electronic mail scheduled to be transmitted is not the illegal electronic mail, and transmits the electronic mail scheduled to be transmitted.

2. The electronic mail apparatus according to claim 1, wherein, in a case of requesting, with respect to the user, confirmation of whether or not the user intends to transmit the electronic mail scheduled to be transmitted, in addition to the authentication of personal identification, and receiving the response to the effect that the user is identified and a response to the effect that the electronic mail scheduled to be transmitted is an electronic mail intended to be transmitted by the user, the mail checking part determines that the electronic mail scheduled to be transmitted is not the illegal electronic mail.

3. The electronic mail apparatus according to claim 1, comprising a security apparatus for verifying whether or not the electronic mail apparatus is operated in accordance with an instruction of the computer virus.

4. The electronic mail apparatus according to claim 3, comprising an input history monitoring part,
wherein the input history monitoring part obtains input history information specifying an input history when the user creates an electronic mail, stores the input history information in the security apparatus, and monitors acquisition of the input history information by the computer virus, and
the mail checking part compares the input history information stored in the security apparatus with contents of the electronic mail scheduled to be transmitted, and in a case where an entirety or a part of sentences constituting the electronic mail scheduled to be transmitted is matched with the input history specified by the input history information, the mail checking part transmits the electronic mail scheduled to be transmitted

5. The electronic mail apparatus according to claim 2, further comprising a mail determining part for at least determining whether or not an attached file is present in the electronic mail scheduled to be transmitted,
wherein, in a case where the mail determining part determines that the attached file is not present, the mail checking part determines that the electronic mail scheduled to be transmitted is not the illegal electronic mail, and
in a case where the mail determining part determines that the attached file is present, the mail checking part requests, with respect to the user, authentication of personal identification and confirmation of whether or not the user intends to transmit the electronic mail scheduled to be transmitted, and in a case of receiving a response to the effect that the user is identified and a response to the effect that the electronic mail scheduled to be transmitted is an electronic mail intended to be transmitted by the user, the mail checking part determines that the electronic mail scheduled to be transmitted is not the illegal electronic mail.

6. The electronic mail apparatus according to claim 2, wherein, in accordance with an input signal from outside, the mail checking part transmits all electronic mails scheduled to be transmitted, stops transmitting all the electronic mails scheduled to be transmitted, or stops requesting the authentication of personal identification and the confirmation with respect to all the electronic mails scheduled to be transmitted.

7. The electronic mail apparatus according to claim 3, further comprising a key distribution managing part,
wherein the security apparatus encodes the electronic mail scheduled to be transmitted, and generates and saves a key,
the key distribution managing part determines whether or not to admit distribution of the key for decoding the encoded electronic mail scheduled to be transmitted,
in a case of determining that the electronic mail scheduled to be transmitted is not the illegal electronic mail, the mail checking part allows the security apparatus to encode the electronic mail and transmits the encoded electronic mail, and in a case where another electronic mail apparatus that has received the encoded electronic mail requests transmission of the key for decoding the encoded electronic mail, the mail checking part distributes the key in accordance with determination by the key distribution managing part.

8. The electronic mail apparatus according to claim 2, comprising a mail environment detecting part for detecting an environment for transmitting the electronic mail scheduled to be transmitted, and notifying the mail checking part of a detection result,
wherein the mail checking part determines whether or not to request, with respect to the user, the authentication of personal identification and the confirmation of whether or not the user intends to transmit the electronic mail scheduled to be transmitted, based on the detection result.

9. An electronic mail system comprising an electronic mail apparatus for detecting and disinfecting a computer virus using a pattern file in accordance with a virus disinfection program, and a mail server,
wherein the electronic mail apparatus includes a security apparatus, and the security apparatus at least verifies whether or not the electronic mail apparatus is operated in accordance with an instruction of the computer virus and manages versions of the pattern file and the virus disinfection program, and
the mail server contains information specifying updated versions of the pattern file and the virus disinfection program, determines whether or not the versions of the pattern film and the virus disinfection program managed by the security apparatus have been updated, based on the information specifying the updated versions, and in a case of determining that any of the versions has not be updated, the mail server allows the electronic mail apparatus to request, with respect to a user, authentication of personal identification and confirmation of whether or not the user intends to transmit the electronic mail scheduled to be transmitted.

10. An electronic mail system comprising an electronic mail apparatus and a mail server,
wherein the electronic mail apparatus obtains the information specifying a state of the electronic mail apparatus and transmits the information to the mail server,
the mail server includes a mail checking part,
the mail checking part determines whether or not it is necessary to authenticate personal identification with respect to the user, and it is necessary to confirm whether or not the user intends to transmit an electronic mail scheduled to be transmitted, based on the information transmitted from the electronic mail apparatus,
in a case of determining that the authentication of personal identification and the confirmation are necessary, the mail checking part allows the electronic mail apparatus to perform the authentication of personal identification and the confirmation, and
in a case of receiving a response to the effect that the user is identified and a response to the effect that the electronic mail scheduled to be transmitted is intended to be transmitted by the user, the mail checking part determines that the electronic mail scheduled to be transmitted is not an illegal electronic mail caused by a computer virus, and allows the electronic mail apparatus to transmit the electronic mail scheduled to be transmitted.

11. An electronic mail transmission method capable of suppressing an illegal electronic mail from being transmitted by a computer virus, comprising the operations of:
(a) requesting authentication of personal identification with respect to a user;
(b) in a case of receiving a response to the effect that the user is identified, determining that an electronic mail scheduled to be transmitted is not the illegal electronic mail; and
(c) in a case of determining that the electronic mail scheduled to be transmitted is not the illegal electronic mail, transmitting the electronic mail scheduled to be transmitted.

12. The electronic mail transmission method according to claim 11,
wherein the operation (a) includes requesting confirmation of whether or not the user intends to transmit the electronic mail scheduled to be transmitted, with respect to the user, in addition to the authentication of personal identification, and
the operation (b) includes, in a case of receiving a response to the effect that the user is identified and a response to the effect that the electronic mail scheduled to be transmitted is intended to be transmitted by the user, determining that the electronic mail scheduled to be transmitted is not the illegal electronic mail.

13. The electronic mail transmission method according to claim 11, further comprising the operations of:
obtaining input history information specifying an input history when the user creates an electronic mail; and
comparing the input history information with contents of the electronic mail, and in a case where an entirety or a part of sentences constituting the electronic mail scheduled to be transmitted is matched with the input history specified by the input history information, determining that the electronic mail scheduled to be transmitted is not the illegal electronic mail.

14. The electronic mail transmission method according to claim 11, comprising the operations of:
determining whether or not an attached file is present in the electronic mail scheduled to be transmitted, and in a case of determining that the attached file is not present, determining that the electronic mail scheduled to be transmitted is not the illegal electronic mail, transmitting the electronic mail scheduled to be transmitted,
wherein, in a case of determining that the attached file is present, the operations (a) to (c) are performed.

15. The electronic mail transmission method according to claim 11, further comprising the operations of:
in the operation (b), in a case of determining that the electronic mail scheduled to be transmitted is not the illegal electronic mail, encoding the electronic mail scheduled to be transmitted;
generating a key for decoding the encoded electronic mail scheduled to be transmitted;
in a case where an electronic mail apparatus that has received the encoded electronic mail scheduled to be transmitted requests transmission of the key, determining whether or not a mail address of a transmission destination of the electronic mail is matched with a mail address of the electronic mail apparatus, and whether or not a previously registered domain name is matched with a domain name of a mail address of the electronic mail apparatus; and
in a case where the mail address of the transmission destination of the electronic mail is matched with the mail address of the electronic mail apparatus, or in a case where the previously registered domain name is matched with the domain name of the mail address of the electronic mail apparatus, distributing the key.

16. The electronic mail transmission method according to claim 12, further comprising the operation of determining whether or not to request, with respect to the user, the authentication of personal identification and the confirmation of whether or not the user intends to transmit the electronic mail scheduled to be transmitted, based on the environment for transmitting an electronic mail.

17. An electronic mail transmission method using an electronic mail apparatus for detecting and disinfecting a computer virus using a pattern file in accordance with a virus disinfection program, and a mail server, comprising at least the operations of:
(a) obtaining versions of the pattern file and the virus disinfection program by the mail server;
(b) determining by the mail server whether or not the versions of the pattern file and the virus disinfection program have been updated, based on information specifying updated versions of the pattern file and the virus disinfection program previously stored in the mail server;
(c) in the operation (b), in a case of determining that any of the versions has not been updated, the mail server allowing the electronic mail apparatus to request, with respect to the user, authentication of personal identification and confirmation of whether or not the user intends to transmit the electronic mail scheduled to be transmitted.

18. The electronic mail transmission method using an electronic mail apparatus and a mail server, comprising the operations of:
(a) allowing the electronic mail apparatus to transmit the information specifying a state of the electronic mail apparatus to the mail server;
(b) allowing the mail server to determine whether or not it is necessary to authenticate personal identification with respect to the user and confirm whether or not the user intends to transmit the electronic mail scheduled to be transmitted, based on the information transmitted from the electronic mail apparatus;
(c) in a case of determining that the authentication of personal identification and the confirmation are necessary, allowing the electronic mail apparatus to perform the authentication of personal identification and the confirmation; and
(d) in a case where the mail server receives a response to the effect that the user is identified and a response to the effect that the electronic mail scheduled to be transmitted is an electronic mail intended to be transmitted by the user, allowing the electronic mail apparatus to transmit the electronic mail.
